(19) United States
(12) Patent Application Publication
(10) Pub. No.: US 2023/0030429 A1
(43) Pub. Date: Feb. 2, 2023

(54) INFORMATION PROCESSING APPARATUS, TEXT DATA EDITING METHOD, AND COMMUNICATION SYSTEM

(71) Applicant: Takuro Mano, Kanagawa (JP)

(72) Inventor: Takuro Mano, Kanagawa (JP)

(73) Assignee: Ricoh Company, Ltd., Tokyo (JP)

(21) Appl. No.: 17/809,987

(22) Filed: Jun. 30, 2022

(30) Foreign Application Priority Data
Jul. 30, 2021 (JP) 2021-126102

(51) Int. Cl. G06F 40/166; G06F 3/14

(52) U.S. Cl. CPC G06F 40/166; G06F 3/1454

(57) ABSTRACT

An information processing apparatus communicates with a plurality of terminals via a network. The information processing apparatus includes circuitry. The circuitry transmits text data to a first terminal and a second terminal of the plurality of terminals. The text data is converted from audio data transmitted from a particular terminal of the plurality of terminals. In response to receipt of a notification of start of editing the text data from the first terminal, the circuitry restricts editing of the text data by the second terminal. In response to receipt of the edited text data from the first terminal, the circuitry transmits at least an edited character of the edited text data to the second terminal.

### CROSS-REFERENCE TO RELATED APPLICATION

This patent application is based on and claims priority pursuant to 35 U.S.C. § 119(a) to Japanese Patent Application No. 2021-126102, filed on Jul. 30, 2021, in the Japan Patent Office, the entire disclosure of which is hereby incorporated by reference herein.

### BACKGROUND

### Technical Field

The present invention relates to an information processing apparatus, a text data editing method, and a communication system.

### Description of the Related Art

There is a communication system that transmits and receives image and audio between remote locations via a network.

Examples of the above-described communication system include a communication system that converts the audio of a video conference into text through voice recognition to support the video conference.

When a participant of the video conference or an editor edits the text with a first terminal, however, the result of the editing is not transmitted to a second terminal that is capable of displaying the text. Since the text generated by the voice recognition does not necessarily perfectly reflect the intention of a speaker, it is desirable that the text be edited by the editor. According to a method in which the editor later corrects the text of meeting minutes, for example, the editor corrects a substantial amount of text by checking the text against his or her memory (or by guessing the context). Further, a participant of the video conference may understand the contents of the conference by reading the text. In this case, slow editing may hinder the participant from correctly understanding the contents of the conference due to incorrect text.

### SUMMARY

In one embodiment of this invention, there is provided an information processing apparatus that communicates with a plurality of terminals via a network. The information processing apparatus includes, for example, circuitry that transmits text data to a first terminal and a second terminal of the plurality of terminals. The text data is converted from audio data transmitted from a particular terminal of the plurality of terminals. In response to receipt of a notification of start of editing the text data from the first terminal, the circuitry restricts editing of the text data by the second terminal. In response to receipt of the edited text data from the first terminal, the circuitry transmits at least an edited character of the edited text data to the second terminal.

In one embodiment of this invention, there is provided a text data editing method performed by an information processing apparatus that communicates with a plurality of terminals via a network. The text data editing method includes, for example, transmitting text data to a first terminal and a second terminal of the plurality of terminals. The text data is converted from audio data transmitted from a particular terminal of the plurality of terminals. The text data editing method further includes, in response to receipt of a notification of start of editing the text data from the first terminal, restricting editing of the text data by the second terminal, and in response to receipt of the edited text data from the first terminal, transmitting at least an edited character of the edited text data to the second terminal.

In one embodiment of this invention, there is provided a communication system that includes, for example, a plurality of terminals and an information processing apparatus. The plurality of terminals include a first terminal and a second terminal. The information processing apparatus communicates with the plurality of terminals via a network. The information processing apparatus includes apparatus circuitry that transmits text data to the first terminal and the second terminal. The text data is converted from audio data transmitted from a particular terminal of the plurality of terminals. In response to receipt of a notification of start of editing the text data from the first terminal, the apparatus circuitry restricts editing of the text data by the second terminal. In response to receipt of the edited text data from the first terminal, the apparatus circuitry transmits at least an edited character of the edited text data to the second terminal. The first terminal includes first terminal circuitry. The first terminal circuitry displays the text data received from the information processing apparatus, and receives the editing of the text data. The second terminal includes second terminal circuitry. The second terminal circuitry displays the text data received from the information processing apparatus. Based on the at least edited character of the edited text data received from the information processing apparatus, the second terminal circuitry changes the text data being displayed.

### BRIEF DESCRIPTION I/F THE SEVERAL VIEWS I/F THE DRAWINGS

A more complete appreciation of the disclosure and many of the attendant advantages and features thereof can be readily obtained and understood from the following detailed description with reference to the accompanying drawings, wherein:

FIG. 1 is a schematic view of a communication system according to an embodiment of the present invention;

FIG. 2 is a diagram illustrating a hardware configuration of a video conference terminal included in the communication system of the embodiment;

FIG. 3 is a diagram illustrating a hardware configuration of a vehicle navigation system included in the communication system of the embodiment;

FIG. 4 is a diagram illustrating a hardware configuration of each of a communication terminal, a personal computer (PC), a display terminal, and servers included in the communication system of the embodiment;

FIGS. 5A and 5B of FIG. 5 are a functional block diagram of the communication system of the embodiment;

FIG. 6A is a conceptual diagram of a user authentication management table of the embodiment;

FIG. 6B is a conceptual diagram of an access management table of the embodiment;

FIG. 6C is a conceptual diagram of a schedule management table of the embodiment;

FIG. 7 is a conceptual diagram of a content management table of the embodiment;

FIG. 8A is a conceptual diagram of a user authentication management table of the embodiment;

FIG. 8B is a conceptual diagram of a user management table of the embodiment;

FIG. 8C is a conceptual diagram of a shared item management table of the embodiment;

FIG. 9A is a conceptual diagram of a shared item reservation management table of the embodiment;

FIG. 9B is a conceptual diagram of an event management table of the embodiment;

FIG. 10A is a conceptual diagram of a server authentication management table of the embodiment;

FIG. 10B is a conceptual diagram of an executed event history management table of the embodiment;

FIG. 11A is a conceptual diagram of an executed event management table of the embodiment;

FIG. 11B is a conceptual diagram of a related information management table of the embodiment;

FIG. 12 is a conceptual diagram of a text information management table of the embodiment;

FIG. 13 is a sequence diagram illustrating a schedule registration process of the embodiment;

FIG. 14 is a diagram illustrating a sign-in screen of the embodiment;

FIG. 15 is a diagram illustrating an example of an initial screen displayed on the PC of the embodiment;

FIG. 16 is a diagram illustrating a schedule input screen of the embodiment;

FIG. 17 is a sequence diagram illustrating an event starting process of the embodiment;

FIG. 18 is a diagram illustrating a sign-in screen displayed on the communication terminal of the embodiment;

FIG. 19 is a diagram illustrating a shared item reservation list screen of the embodiment;

FIG. 20 is a sequence diagram illustrating the event starting process of the embodiment;

FIG. 21 is a diagram illustrating a detailed event information screen of the embodiment;

FIG. 22 is a diagram illustrating a display screen displayed on the communication terminal of the embodiment when an event starts;

FIG. 23 is a sequence diagram illustrating an executed event history registration process of the embodiment;

FIG. 24 is a flowchart illustrating an audio-to-text conversion process of the embodiment;

FIG. 25 is a sequence diagram illustrating the executed event history registration process of the embodiment;

FIG. 26 is a sequence diagram illustrating a process of the embodiment, in which the PC receives editing of text data and transmits the contents of the editing to the communication terminal;

FIG. 27 is a diagram illustrating an example of a text display screen displayed by the display terminal of the embodiment;

FIG. 28 is a diagram illustrating an example of a text data editing screen displayed by the PC of the embodiment;

FIG. 29 is a detailed diagram illustrating the text data editing screen of the embodiment;

FIG. 30A is a diagram illustrating an example of the text display screen displayed by the display terminal of the embodiment during the editing;

FIG. 30B is a diagram illustrating an example of an icon of the embodiment displayed in place of a message;

FIG. 31 is a diagram illustrating an example of the text data editing screen displayed in the embodiment after the editing of the text data;

FIG. 32 is a diagram illustrating the text data displayed by the display terminal of the embodiment after the editing; and

FIG. 33 is a diagram illustrating an example of a content display screen of the embodiment displayed after the completion of a meeting.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As an exemplary embodiment for implementing the present invention, a communication system and a text data editing method performed by the communication system will be described below with reference to the drawings.

According to a sharing support server of the present embodiment, while text data converted from audio of a meeting is being viewed by viewers, the text data is edited in real time by an editor and reflected in the text data viewed by the viewers. Consequently, the text data edited by the editor is displayed in substantially real time on display terminals of the viewers. When a person with hearing difficulty relies on the text generated by voice recognition to understand the contents of the meeting, for example, the text is promptly corrected, helping the person to correctly understand the contents of the meeting. Further, in a case in which the editor later corrects the text data, an increase in the volume of the text data makes it difficult for the editor to accurately correct the text data due to the limited memory capacity of the human brain. The present embodiment facilitates the real-time correction of the text data by the editor, thereby reducing the workload on the editor.

Herein, audio data refers to data converted from sound to be subjected to signal processing. Although the audio data may be analog or digital data, the audio data is digitally converted on a computer. It is assumed here that the audio data mainly represents voices. The audio data, however, may contain any kind of sound.

The text data includes characters such as letters (e.g., alphabet), numbers, and symbols represented by a character code.

The restriction of editing includes the prohibition of editing the entire text data and also the prohibition of editing a character forming part of the text data. The editing includes the addition, deletion, and change of a character.

The term “in real time” refers to that, when a certain process is executed, the result of the process is obtained within a certain range of delay after the execution of the process.

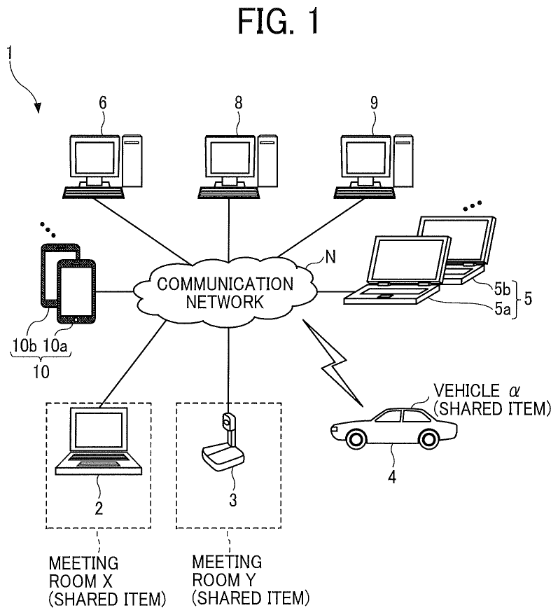

A schematic configuration of a communication system 1 of the present embodiment will be described with reference to FIG. 1.

FIG. 1 is a schematic view of the communication system 1 of the present embodiment. As illustrated in FIG. 1, the communication system 1 of the present embodiment includes a communication terminal 2, a video conference terminal 3, a vehicle navigation system 4, a personal computer (PC) 5, a sharing support server 6, a schedule management server 8, an audio-to-text conversion server 9, and a display terminal 10.

The communication terminal 2, the video conference terminal 3, the vehicle navigation system 4, the PC 5, the sharing support server 6, the schedule management server 8, the audio-to-text conversion server 9, and the display terminal 10 are communicable with each other via a communication network N. The communication network N is implemented by the Internet, a mobile telecommunications network, or a local area network (LAN), for example. The communication network N may include not only a wired communication network but also a wireless communication network conforming to a standard such as third generation (3G), worldwide interoperability for microwave access (WiMAX), or long term evolution (LTE).

The communication terminal 2 is used in a meeting room X. The video conference terminal 3 is used in a meeting room Y. The meeting rooms X and Y may be installed with an electronic whiteboard. Herein, a shared item is what is reserved by a user. The vehicle navigation system 4 is used in a vehicle α. In this case, the vehicle α is a vehicle for car sharing. The vehicle includes an automobile, motorcycle, bicycle, and wheelchair, for example.

The shared item refers to an object, service, space (e.g., room), place, or information shared by a plurality of people or organizations. The meeting rooms X and Y and the vehicle α are examples of the shared item shared by a plurality of users. As an example of information provided to the shared item, there is an account. For example, a particular service provided on the world wide web (Web) may be limited to a single account to use.

The communication terminal 2 is a general-purpose computer such as a tablet terminal or a smartphone. The display terminal 10, the video conference terminal 3, and the vehicle navigation system 4 are also examples of a communication terminal. The communication terminal is a terminal that becomes usable in a video conference between different locations after sign-in by a user (see later-described step S33 in FIG. 17), for example. The communication terminal used in the vehicle α includes, as well as the vehicle navigation system 4, a smartphone or smartwatch installed with an application for vehicle navigation, for example. The display terminal 10 is a general-purpose computer such as a smartphone or PC. The display terminal 10 is an example of a second terminal. The display terminal 10 may include a plurality of display terminals 10, such as display terminals 10a, 10b, and so forth. Hereinafter, any one of the display terminals 10a, 10b, and so forth will be referred to as the display terminal 10.

The PC 5 is a general-purpose computer. The PC 5 is an example of a registration apparatus that registers, on the schedule management server 8, a reservation to use a shared item and an event scheduled to be executed by a user. The event includes a conference, assembly, meeting, gathering, consultation, discussion, drive, ride, and transport, for example. The PC 5 is also used as a terminal by an editor who edits the text data converted from audio. The PC 5 is an example of a first terminal. The PC 5 may include a plurality of PCs 5, such as PCs 5a, 5b, and so forth. Hereinafter, any one of the PCs 5a, 5b, and so forth will be referred to as the PC 5.

The sharing support server 6 is a computer. The sharing support server 6 supports the communication terminals in remotely sharing the shared item. The sharing support server 6 is an example of an information processing apparatus.

The schedule management server 8 is a computer. The schedule management server 8 manages the reservations of shared items and the schedules of users.

The audio-to-text conversion server 9 is a computer. The audio-to-text conversion server 9 converts sound (i.e., audio) data received from an external computer (e.g., the sharing support server 6) into text data.

Herein, the sharing support server 6, the schedule management server 8, and the audio-to-text conversion server 9 will be collectively referred to as the management system. The management system may be a computer that integrates all or part of the functions of the sharing support server 6, the schedule management server 8, and the audio-to-text conversion server 9, for example. Alternatively, the functions of the sharing support server 6, the schedule management server 8, and the audio-to-text conversion server 9 may be distributed to and implemented by a plurality of computers. It is assumed in the following description that each of the sharing support server 6, the schedule management server 8, and the audio-to-text conversion server 9 is a server computer located in a cloud environment. The sharing support server 6 and the audio-to-text conversion server 9, however, may be a server located in an on-premise environment. The schedule management server 8 may also be a server located in an on-premise environment.

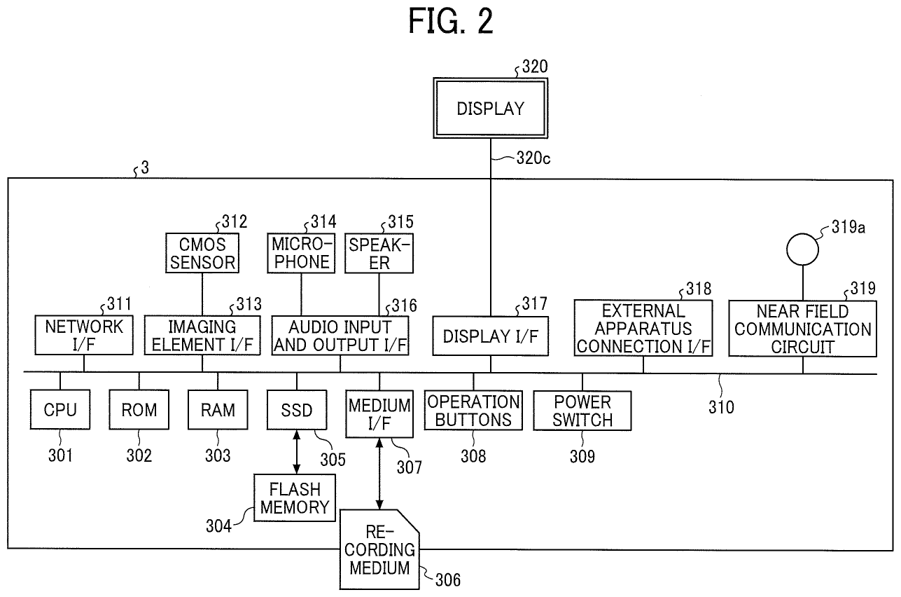

Respective hardware configurations of apparatuses and terminals forming the communication system 1 will be described with reference to FIGS. 2 to 4.

A hardware configuration of the video conference terminal 3 will first be described.

FIG. 2 is a diagram illustrating a hardware configuration of the video conference terminal 3. As illustrated in FIG. 2, the video conference terminal 3 includes a central processing unit (CPU) 301, a read only memory (ROM) 302, a random access memory (RAM) 303, a flash memory 304, a solid state drive (SSD) 305, a medium interface (I/F) 307, operation buttons 308, a power switch 309, a bus line 310, a network I/F 311, a complementary metal oxide semiconductor (CMOS) sensor 312, an imaging element I/F 313, a microphone 314, a speaker 315, an audio input and output I/F 316, a display I/F 317, an external apparatus connection I/F 318, a near field communication circuit 319, and an antenna 319a for the near field communication circuit 319.

The CPU 301 controls overall operation of the video conference terminal 3. The ROM 302 stores a program used to drive the CPU 301, such as an initial program loader (IPL). The RAM 303 is used as a work area for the CPU 301. The flash memory 304 stores a communication program and various data such as image data and audio data. The SSD 305 controls writing and reading of various data to and from the flash memory 304 under the control of the CPU 301. The SSD 305 may be replaced by a hard disk drive (HDD). The medium I/F 307 controls writing (i.e., storage) and reading of data to and from a recording medium 306 such as a flash memory. The operation buttons 308 are buttons operated to select the address of the video conference terminal 3, for example. The power switch 309 is a switch for turning on or off the power supply of the video conference terminal 3.

The network I/F 311 is an interface for performing data communication via the communication network N such as the Internet. The CMOS sensor 312 is a built-in imaging device that captures the image of a subject under the control of the CPU 301 to obtain image data. The imaging element I/F 313 is a circuit that controls the driving of the CMOS sensor 312. The microphone 314 is a built-in sound collector that receives input of audio. The audio input and output I/F 316 is a circuit that processes the input of an audio signal from the microphone 314 and the output of an audio signal to the speaker 315 under the control of the CPU 301. The display I/F 317 is a circuit that transmits image data to an external display 320 under the control of the CPU 301. The external apparatus connection I/F 318 is an interface for connecting the video conference terminal 3 to various external apparatuses. The near field communication circuit 319 is a communication circuit conforming to a standard such as near field communication (NFC) or Bluetooth (registered trademark).

The bus line 310 includes an address bus and a data bus for electrically connecting the CPU 301 and the other components in FIG. 2 to each other.

The display 320 is a display (i.e., display device) implemented as a liquid crystal or organic electroluminescence (EL) display that displays the image of the subject and icons for operations, for example. The display 320 is connected to the display I/F 317 via a cable 320c. The cable 320c may be a cable for analog red-green-blue (RGB) video graphics array (VGA) signal, a cable for component video, or a cable for DisplayPort (registered trademark), high-definition multimedia interface (HDMI, registered trademark), or digital video interactive (DVI) signal.

The CMOS sensor 312 may be an imaging element such as a charge coupled device (CCD) sensor. The external apparatus connection I/F 318 is connectable to an external apparatus such as an external camera, microphone, or speaker via a universal serial bus (USB) cable, for example. If an external camera is connected to the external apparatus connection I/F 318, the external camera is driven in preference to the built-in CMOS sensor 312 under the control of the CPU 301. Similarly, if an external microphone or speaker is connected to the external apparatus connection I/F 318, the external microphone or speaker is driven in preference to the built-in microphone 314 or the built-in speaker 315 under the control of the CPU 301.

The recording medium 306 is removable from the video conference terminal 3. The flash memory 304 may be replaced by any nonvolatile memory for reading or writing data under the control of the CPU 301, such as an electrically erasable programmable ROM (EEPROM).

A hardware configuration of the vehicle navigation system 4 will be described.

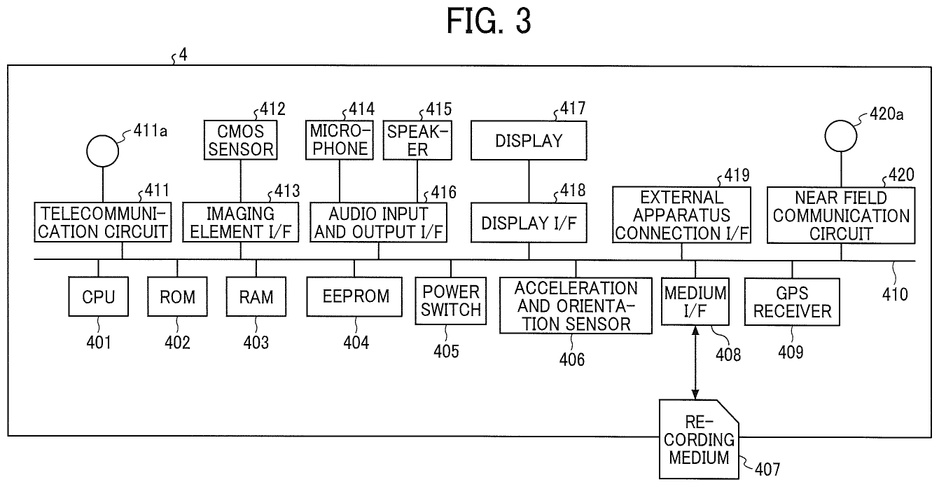

FIG. 3 is a diagram illustrating a hardware configuration of the vehicle navigation system 4. As illustrated in FIG. 3, the vehicle navigation system 4 includes a CPU 401, a ROM 402, a RAM 403, an EEPROM 404, a power switch 405, an acceleration and orientation sensor 406, a medium I/F 408, and a global positioning system (GPS) receiver 409.

The CPU 401 controls overall operation of the vehicle navigation system 4. The ROM 402 stores a program used to drive the CPU 401 such as an IPL. The RAM 403 is used as a work area for the CPU 401. The EEPROM 404 reads or writes various data of a program for the vehicle navigation system 4, for example, under the control of the CPU 401. The power switch 405 is a switch for turning on or off the power supply of the vehicle navigation system 4. The acceleration and orientation sensor 406 includes various sensors such as an electromagnetic compass that detects geomagnetism, a gyrocompass, and an acceleration sensor. The medium I/F 408 controls writing (i.e., storage) and reading of data to and from a recording medium 407 such as a flash memory. The GPS receiver 409 receives a GPS signal from a GPS satellite.

The vehicle navigation system 4 further includes a telecommunication circuit 411, an antenna 411a for the telecommunication circuit 411, a CMOS sensor 412, an imaging element I/F 413, a microphone 414, a speaker 415, an audio input and output I/F 416, a display 417, a display I/F 418, an external apparatus connection I/F 419, a near field communication circuit 420, and an antenna 420a for the near field communication circuit 420.

The telecommunication circuit 411 is a circuit that receives information provided by an external infrastructure outside the vehicle α, such as traffic congestion information, road construction information, and traffic accident information, and transmits positional information of the vehicle α and an emergency rescue signal, for example, to the outside of the vehicle α. The external infrastructure is a road information guide system such as the vehicle information and communication system (VICS, registered trademark), for example. The CMOS sensor 412 is a built-in imaging device that captures the image of a subject under the control of the CPU 401 to obtain image data. The imaging element I/F 413 is a circuit that controls the driving of the CMOS sensor 412. The microphone 414 is a built-in sound collector that receives the input of audio. The audio input and output I/F 416 is a circuit that processes the input of an audio signal from the microphone 414 and the output of an audio signal to the speaker 415 under the control of the CPU 401. The display 417 is a display (i.e., display device) such as a liquid crystal or organic EL display, for example, which displays the image of the subject and various icons, for example. The display 417 has the function of a touch panel. The touch panel is an input device for a user to operate the vehicle navigation system 4. The display I/F 418 is a circuit that causes the display 417 to display the image. The external apparatus connection I/F 419 is an interface for connecting the vehicle navigation system 4 to various external apparatuses. The near field communication circuit 420 is a communication circuit conforming to a standard such as NFC or Bluetooth. The vehicle navigation system 4 further includes a bus line 410. The bus line 410 includes an address bus and a data bus for electrically connecting the CPU 401 and the other components in FIG. 3 to each other.

A description will be given of respective hardware configurations of the communication terminal 2, the PC 5, the display terminal 10, the sharing support server 6, the schedule management server 8, and the audio-to-text conversion server 9.

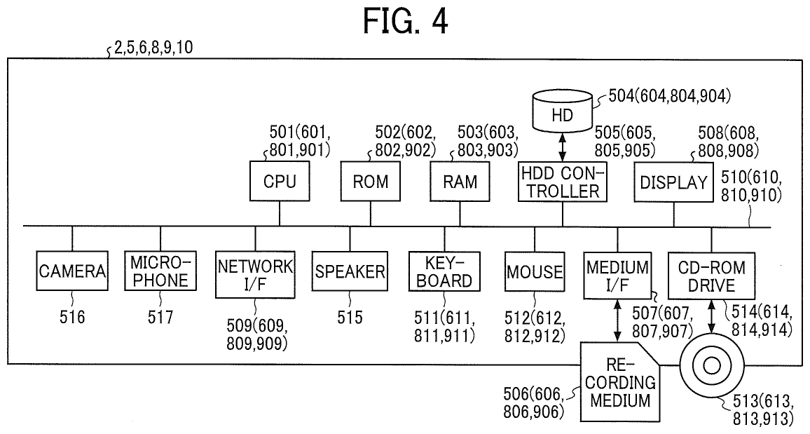

FIG. 4 is a diagram illustrating a hardware configuration of each of the communication terminal 2, the PC 5, the display terminal 10, the sharing support server 6, the schedule management server 8, and the audio-to-text conversion server 9. Each of the communication terminal 2, the PC 5, and the display terminal 10 is implemented by a computer, and includes a CPU 501, a ROM 502, a RAM 503, an HD 504, an HDD controller 505, a medium I/F 507, a display 508, a network I/F 509, a keyboard 511, a mouse 512, a compact disc-rewritable (CD-RW) drive 514, a speaker 515, a camera 516, a microphone 517, and a bus line 510, as illustrated in FIG. 4.

The CPU 501 controls overall operation of the communication terminal 2, the PC 5, or the display terminal 10. The ROM 502 stores a program used to drive the CPU 501 such as an IPL. The RAM 503 is used as a work area for the CPU 501. The HD 504 stores various data of programs, for example. The HDD controller 505 controls writing and reading of various data to and from the HD 504 under the control of the CPU 501. The medium I/F 507 controls writing (i.e., storage) and reading of data to and from a recording medium 506 such as a flash memory. The display 508 displays various information such as a cursor, menus, windows, text, and images. The display 508 is an example of a display (i.e., display device). The network I/F 509 is an interface for performing data communication via the communication network N. The keyboard 511 is an input device including a plurality of keys for inputting text, numerical values, and various instructions, for example. The mouse 512 is an input device used to select and execute various instructions, select a processing target, and move the cursor, for example. The CD-RW drive 514 controls writing and reading of various data to and from a CD-RW 513 as an example of a removable recording medium. The speaker 515 outputs an audio signal under the control of the CPU 501. The camera 516 captures the image within the angle of view under the control of the CPU 501 to generate image data. The microphone 517 collects an audio signal under the control of the CPU 501. The bus line 510 includes an address bus and a data bus for electrically connecting the CPU 501 and the other components in FIG. 4 to each other.

The sharing support server 6 is implemented by a computer. As illustrated in FIG. 4, the sharing support server 6 includes a CPU 601, a ROM 602, a RAM 603, an HD 604, an HDD controller 605, a recording medium 606, a medium I/F 607, a display 608, a network I/F 609, a keyboard 611, a mouse 612, a CD-RW drive 614, and a bus line 610. In the sharing support server 6, these components are similar in configuration to the CPU 501, the ROM 502, the RAM 503, the HD 504, the HDD controller 505, the recording medium 506, the medium I/F 507, the display 508, the network I/F 509, the keyboard 511, the mouse 512, the CD-RW drive 514, and the bus line 510, and thus description thereof will be omitted.

The schedule management server 8 is implemented by a computer. As illustrated in FIG. 4, the schedule management server 8 includes a CPU 801, a ROM 802, a RAM 803, an HD 804, an HDD controller 805, a recording medium 806, a medium I/F 807, a display 808, a network I/F 809, a keyboard 811, a mouse 812, a CD-RW drive 814, and a bus line 810. In the schedule management server 8, these components are similar in configuration to the CPU 501, the ROM 502, the RAM 503, the HD 504, the HDD controller 505, the recording medium 506, the medium I/F 507, the display 508, the network I/F 509, the keyboard 511, the mouse 512, the CD-RW drive 514, and the bus line 510, and thus description thereof will be omitted.

The audio-to-text conversion server 9 is implemented by a computer. As illustrated in FIG. 4, the audio-to-text conversion server 9 includes a CPU 901, a ROM 902, a RAM 903, an HD 904, an HDD controller 905, a recording medium 906, a medium I/F 907, a display 908, a network I/F 909, a keyboard 911, a mouse 912, a CD-RW drive 914, and a bus line 910. In the audio-to-text conversion server 9, these components are similar in configuration to the CPU 501, the ROM 502, the RAM 503, the HD 504, the HDD controller 505, the recording medium 506, the medium I/F 507, the display 508, the network I/F 509, the keyboard 511, the mouse 512, the CD-RW drive 514, and the bus line 510, and thus description thereof will be omitted.

Each of the above-described programs may be distributed as recorded on a computer readable recording medium in an installable or executable file format. Examples of the recording medium include a CD-recordable (CD-R), a digital versatile disc (DVD), a Blu-ray (registered trademark) disc, and a secure digital (SD) card. The recording medium may be shipped to the market as a program product. For example, with the execution of a program of the present invention, the communication terminal 2, the PC 5, or the display terminal 10 implements a text data editing method of the present invention.

The sharing support server 6 may be implemented by a single computer, or may be implemented by a plurality of computers to which units (e.g., functions or devices and memories) of the sharing support server 6 are divided and allocated as desired. The same applies to the schedule management server 8 and the audio-to-text conversion server 9.

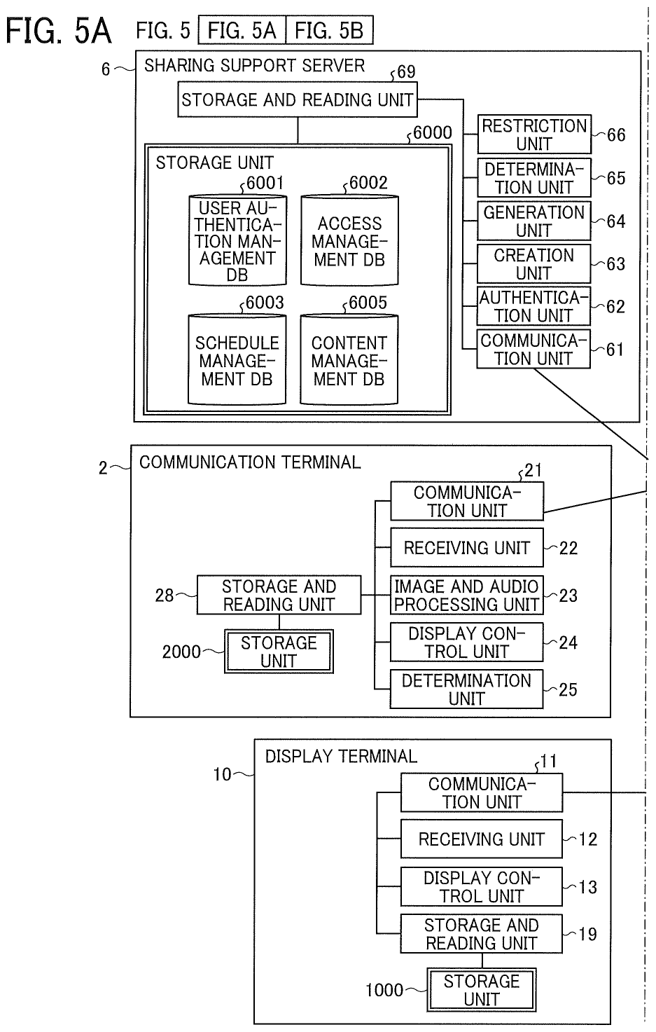

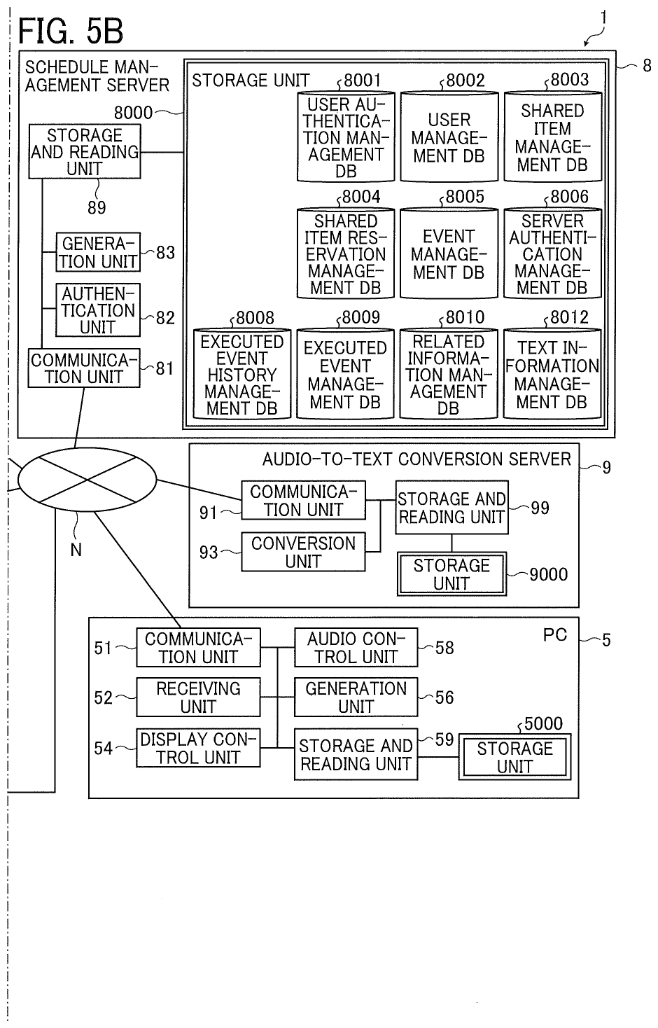

A functional configuration of the communication system 1 of the present embodiment will be described with reference to FIGS. 5 to 12.

FIGS. 5A and 5B of FIG. 5 are a functional block diagram of the communication system 1. Out of the terminals, apparatuses, and servers illustrated in FIG. 1, terminals, apparatuses, and servers related to later-described processes or operations are illustrated in FIGS. 5A and 5B.

As for a functional configuration of the communication terminal 2, the communication terminal 2 includes a communication unit 21, a receiving unit 22, an image and audio processing unit 23, a display control unit 24, a determination unit 25, and a storage and reading unit 29, as illustrated in FIG. 5A. These units are functions or functional units implemented when at least one of the components illustrated in FIG. 4 operates based on a command from the CPU 501 in accordance with a program deployed on the RAM 503 from the HD 504. The communication terminal 2 further includes a storage unit 2000 implemented by the RAM 503 and the HD 504 illustrated in FIG. 4.

The functional units of the communication terminal 2 will be described.

The communication unit 21 is implemented by a command from the CPU 501 and the network I/F 509 illustrated in FIG. 4. The communication unit 21 transmits and receives various data (or information) to and from another terminal, apparatus, or system via the communication network N.

The receiving unit 22 is mainly implemented by a command from the CPU 501, the keyboard 511, the mouse 512, and the display 508 with a touch panel illustrated in FIG. 4. The receiving unit 22 receives various inputs from a user.

The image and audio processing unit 23 performs image processing on the image data of the image of the subject captured by the camera 516. The image and audio processing unit 23 further performs audio processing on audio data related an audio signal converted from the voice of the user by the microphone 517. The image and audio processing unit 23 further outputs an audio signal related to audio data to the speaker 515 to output sound from the speaker 515.

The display control unit 24 is implemented by a command from the CPU 501 illustrated in FIG. 4. The display control unit 24 causes the display 508 to display a rendered image, or accesses the sharing support server 6 via a Web browser to display various screen data.

The determination unit 25 is implemented by a command from the CPU 501 illustrated in FIG. 4. The determination unit 25 makes various determinations.

The storage and reading unit 29 is implemented by a command from the CPU 501 and the HD 504 illustrated in FIG. 4. The storage and reading unit 29 performs processes such as storing various data in the storage unit 2000 and reading the various data stored therein. Each time the image data and the audio data are received in the communication with another communication terminal or the video conference terminal 3, the image data and the audio data stored in the storage unit 2000 are overwritten with the received image data and the received audio data. The display 508 displays the image based on the image data before being overwritten with the received image data, and the speaker 515 outputs the sound based on the audio data before being overwritten with the received audio data.

Each of the video conference terminal 3 and the vehicle navigation system 4 has functions similar to those of the communication terminal 2, and thus description thereof will be omitted here.

As for a functional configuration of the PC 5, the PC 5 includes a communication unit 51, a receiving unit 52, a display control unit 54, a generation unit 56, an audio control unit 58, and a storage and reading unit 59. These units are functions or functional units implemented when at least one of the components illustrated in FIG. 4 operates based on a command from the CPU 501 in accordance with a program deployed on the RAM 503 from the HD 504. The PC 5 further includes a storage unit 5000 implemented by the HD 504 illustrated in FIG. 4.

The functional units of the PC 5 will be described.

The communication unit 51 is implemented by a command from the CPU 501 and the network I/F 509 illustrated in FIG. 4. The communication unit 51 transmits and receives various data (or information) to and from another terminal, apparatus, or system via the communication network N.

The receiving unit 52 is mainly implemented by a command from the CPU 501, the keyboard 511, and the mouse 512 illustrated in FIG. 4. The receiving unit 52 receives various inputs from a user.

The display control unit 54 is implemented by a command from the CPU 501 illustrated in FIG. 4. The display control unit 54 causes the display 508 to display an image, or accesses the sharing support server 6 via a Web browser to display various screen data. The display control unit 54 downloads a Web application (WebApp) using at least hypertext markup language (HTML) and also using cascading style sheets (CSS) or JavaScript (registered trademark), for example, and causes the display 508 to display various image data generated by the WebApp. For example, the display control unit 54 causes the display 508 to display the image data generated by HTML5 including data in a format such as extensible markup language (XML), JavaScript object notation (JSON), or simple object access protocol (SOAP).

The generation unit 56 is implemented by a command from the CPU 501 illustrated in FIG. 4. The generation unit 56 is a function that generates various image data to be displayed on the display 508. The generation unit 56 generates the various image data with content data received by the communication unit 51. For example, the generation unit 56 renders text data (i.e., content data) and generates image data related to the text data (i.e., content image data) to display the rendered data. Herein, rendering refers to a process of interpreting data described in a language for describing Web pages (e.g., HTML, CSS, or XML) and calculating the layout of text and image data to be actually displayed on a screen.

The audio control unit 58 is implemented by a command from the CPU 501 illustrated in FIG. 4. The audio control unit 58 is a function that outputs the audio signal from the speaker 515. The audio control unit 58 sets the audio data to be output from the speaker 515, and causes the speaker 515 to output the audio signal according to the set audio data, to thereby reproduce the audio data.

The storage and reading unit 59 is implemented by a command from the CPU 501 and the HDD controller 505 illustrated in FIG. 4, for example. The storage and reading unit 59 performs processes such as storing various data in the storage unit 5000 and reading therefrom the various data.

As for a functional configuration of the sharing support server 6, the sharing support server 6 includes a communication unit 61, an authentication unit 62, a creation unit 63, a generation unit 64, a determination unit 65, a restriction unit 66, and a storage and reading unit 69. These units are functions or functional units implemented when at least one of the components illustrated in FIG. 4 operates based on a command from the CPU 601 in accordance with a sharing support program deployed on the RAM 603 from the HD 604. The sharing support server 6 further includes a storage unit 6000 implemented by, for example, the HD 604 illustrated in FIG. 4.

A user authentication management table of the present embodiment will be described.

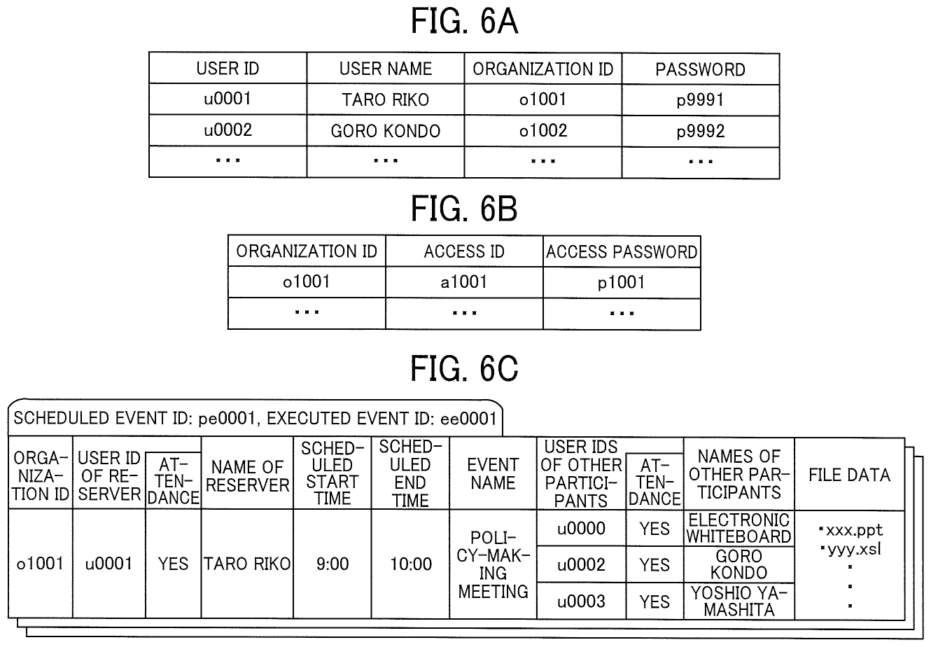

FIG. 6A is a conceptual diagram illustrating the user authentication management table. The storage unit 6000 includes a user authentication management database (DB) 6001 implemented by the user authentication management table as illustrated in FIG. 6A. In the user authentication management table, a user identifier (ID) for identifying the user, a user name, an organization ID for identifying the organization to which the user belongs, and a password are managed in association with each other. The organization ID includes a domain name representing a group or organization to manage a plurality of computers on the communication network N.

An access management table of the present embodiment will be described.

FIG. 6B is a conceptual diagram illustrating the access management table. The storage unit 6000 includes an access management DB 6002 implemented by the access management table as illustrated in FIG. 6B. In the access management table, the organization ID, an access ID, and an access password are managed in association with each other. The access ID and the access password are used for authentication in the access to the schedule management server 8. The access ID and the access password are used when the sharing support server 6 uses a service (i.e., function) provided by the schedule management server 8 via a WebApp, for example, with a protocol such as hypertext transfer protocol (HTTP) or hypertext transfer protocol secure (HTTPS). The schedule management server 8 manages a plurality of schedulers. Different organizations may use different schedulers, and thus the schedulers are managed in the access management table.

A schedule management table of the present embodiment will be described.

FIG. 6C is a conceptual diagram illustrating the schedule management table. The storage unit 6000 includes a schedule management DB 6003 implemented by the schedule management table as illustrated in FIG. 6C. In the schedule management table, the organization ID, the user ID of a reserver, the attendance of the reserver, the name of the reserver, a scheduled start time, a scheduled end time, an event name, user IDs of other participants, the attendance of the other participants, the names of the other participants, and file data are managed in association with each other for each scheduled event ID and executed event ID.

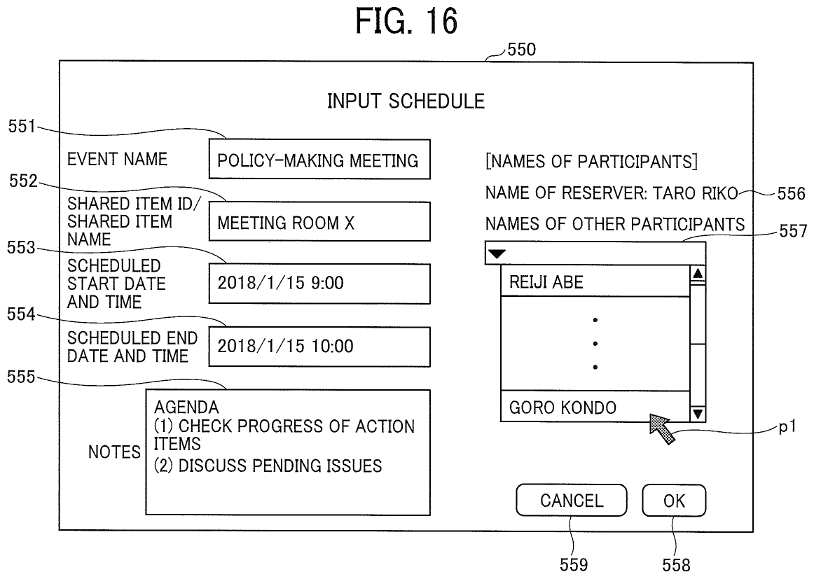

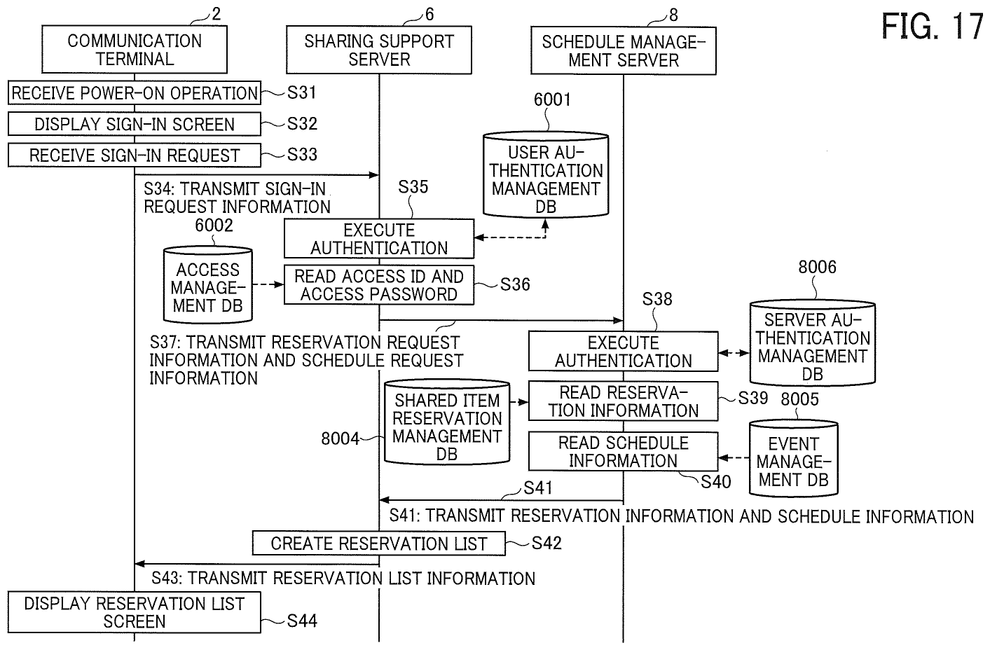

The scheduled event ID is identification information for identifying a scheduled event. The scheduled event ID is an example of scheduled event identification information for identifying an event scheduled to be executed. The executed event ID is identification information for identifying a scheduled event that has actually been executed or is actually being executed. The executed event ID is an example of executed event identification information for identifying an executed event or an event being executed. The name of the reserver is the name of the person who has reserved the shared item. If the shared item is a meeting room, the name of the reserver is the name of the organizer of a meeting in the meeting room, for example. If the shared item is a vehicle, the name of the reserver is the name of the driver of the vehicle, for example. The schedule start time represents the time at which the use of the shared item is scheduled to start. The schedule end time represents the time at which the use of the shared item is scheduled to end. The event name represents the name of the event scheduled to be executed by the reserver. The user IDs of the other participants are identification information for identifying the participants other than the reserver. The names of the other participants are the names of the participants other than the reserver, and include the name of the shared item. That is, the users in this case include the shared item as well as the reserver and the other participants. The file data is the file data of a material file used in the event corresponding to the scheduled event ID, i.e., the event registered by a user A on a later-described schedule input screen 550 in FIG. 16. The file data is data in a particular file format created with various applications. The file format of the file data may be PowerPoint (registered trademark) or Excel (registered trademark), for example.

A content management table of the present embodiment will be described.

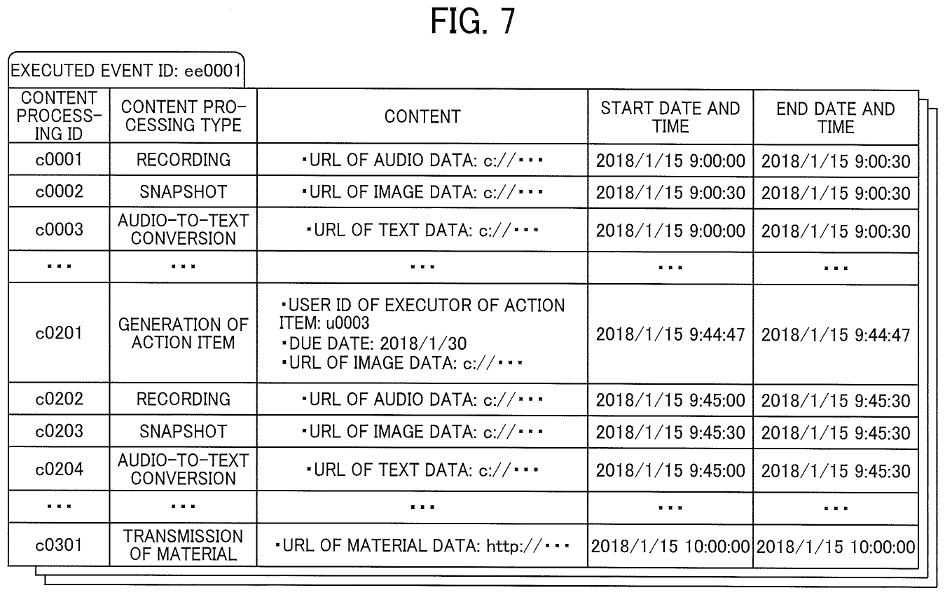

FIG. 7 is a conceptual diagram illustrating the content management table. The storage unit 6000 includes a content management DB 6005 implemented by the content management table as illustrated in FIG. 7. In the content management table, a content processing ID, a content processing type, content, and start date and time and end date and time of the content processing are managed in association with each other for each executed event ID. Herein, the content represents the contents of an executed event generated in the event such as a meeting or material used in the event, for example. The content processing type includes recording, snapshot, audio-to-text conversion, the generation of an action item, and the transmission of material, for example. The content processing ID is identification information for identifying the content processing generated in each event.

Herein, the content includes history information representing the executed contents of the event and an action item generated by the executed event. The history information represents recorded data or the data of snapshot, audio text, or material, for example. Snapshot refers to a process in which a display screen displayed at a certain point of time in an ongoing event is acquired as image data. Snapshot may also be referred to as capture or image recognition, for example.

When the content processing type is recording, the content includes a uniform resource locator (URL) representing the storage location of the recorded audio data. When the content processing type is snapshot, the content includes a URL representing the storage location of the image data of the screen acquired by the snapshot (i.e., capture). Capture refers to storing a still or video image displayed on the display 508 as image data. When the content processing type is audio-to-text conversion, the content includes a URL representing the storage location of text data of the received audio text.

Herein, the action item represents the contents of an action that is generated in an event such as a meeting and should be performed by a person involved in the event. When the content processing type is the generation of an action event, the content includes the user ID of an executor of the action item, the due date to complete the action item, and a URL representing the storage location of image data representing the action item.

The functional units of the sharing support server 6 will be described in detail. In the following description of the functional units of the sharing support server 6, the relationships between the functional units of the sharing support server 6 and major ones of the components in FIG. 4 for implementing the functional units of the sharing support server 6 will also be described.

The communication unit 61 of the sharing support server 6 illustrated in FIG. 5A is implemented by a command from the CPU 601 and the network I/F 609 illustrated in FIG. 4. The communication unit 61 transmits and receives various data (or information) to and from another terminal, apparatus, or system via the communication network N.

The authentication unit 62 is implemented by a command from the CPU 601 illustrated in FIG. 4. The authentication unit 62 executes authentication by determining whether the information transmitted from the communication terminal 2 (i.e., the user ID, the organization ID, and the password) corresponds to the information previously registered in the user authentication management DB 6001.

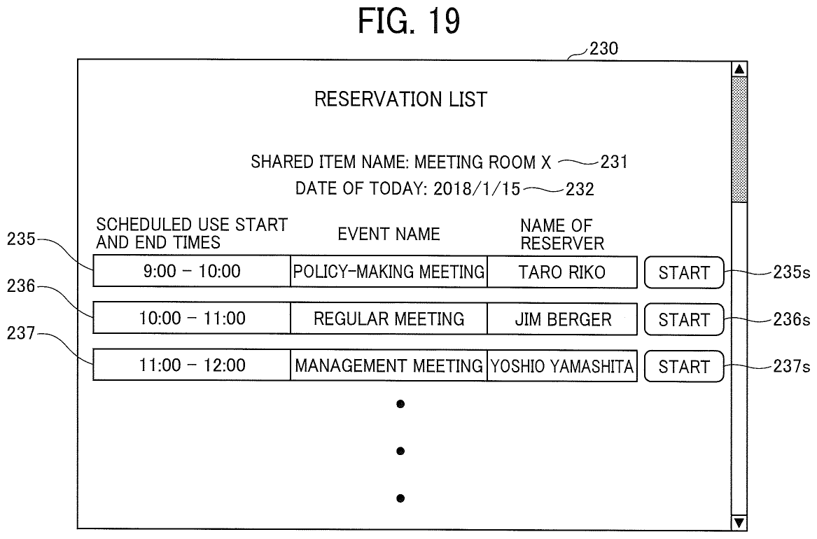

The creation unit 63 is implemented by a command from the CPU 601 illustrated in FIG. 4. Based on reservation information and schedule information transmitted from the schedule management server 8, the creation unit 63 creates a later-described reservation list screen 230 as illustrated in FIG. 19.

The generation unit 64 is implemented by a command from the CPU 601 illustrated in FIG. 4. The generation unit 64 generates the executed event ID, the content processing ID, and the URL of the data storage location.

The determination unit 65 is implemented by a command from the CPU 601 illustrated in FIG. 4. The determination unit 65 makes various determinations, which will be described later.

If the text data starts being edited on one of the PCs 5, the restriction unit 66 restricts the editing of the text data by the other PCs 5 and the display terminals 10. That is, the restriction unit 66 performs exclusion control to prohibit more than one terminal or apparatus from editing the same text data at the same time. When the editor releases the selected text data, the restriction unit 66 lifts the restriction.

The storage and reading unit 69 is implemented by a command from the CPU 601 and the HDD controller 605 illustrated in FIG. 4. The storage and reading unit 69 performs processes such as storing various data in the storage unit 6000 and reading the various data stored therein.

As for a functional configuration of the schedule management server 8, the schedule management server 8 includes a communication unit 81, an authentication unit 82, a generation unit 83, and a storage and reading unit 89. These units are functions or functional units implemented when at least one of the components illustrated in FIG. 4 operates based on a command from the CPU 801 in accordance with a schedule management program deployed on the RAM 803 from the HD 804. The schedule management server 8 further includes a storage unit 8000 implemented by the HD 804 illustrated in FIG. 4.

A user authentication management table of the present embodiment will be described.

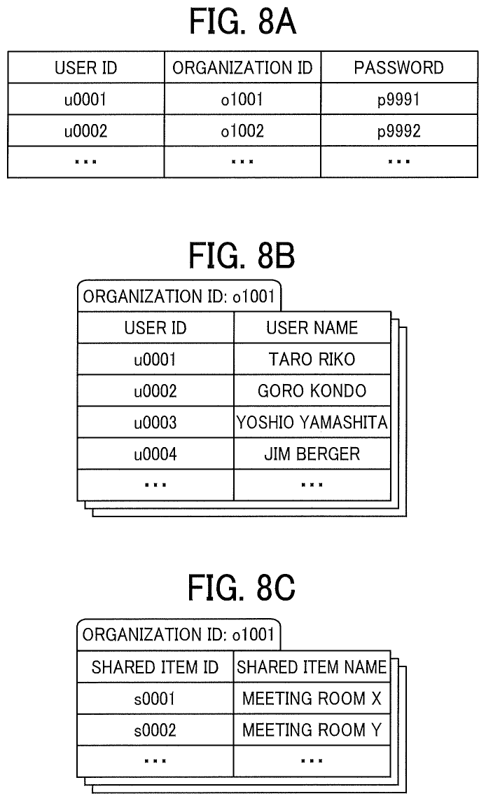

FIG. 8A is a conceptual diagram illustrating the user authentication management table. The storage unit 8000 includes a user authentication management DB 8001 implemented by the user authentication management table as illustrated in FIG. 8A. In the user authentication management table, the organization ID for identifying the organization to which the user belongs and the password are managed in association with the user ID for identifying the user.

A user management table of the present embodiment will be described.

FIG. 8B is a conceptual diagram illustrating the user management table. The storage unit 8000 includes a user management DB 8002 implemented by the user management table as illustrated in FIG. 8B. In the user management table, the user ID and the name of the user corresponding to the user ID (i.e., the user name) are managed in association with each other for each organization ID.

A shared item management table of the present embodiment will be described.

FIG. 8C is a conceptual diagram illustrating the shared item management table. The storage unit 8000 includes a shared item management DB 8003 implemented by the shared item management table as illustrated in FIG. 8C. In the shared item management table, a shared item ID for identifying the shared item and the name of the shared item (i.e., the shared item name) are managed in association with each other for each organization ID.

A shared item reservation management table of the present embodiment will be described.

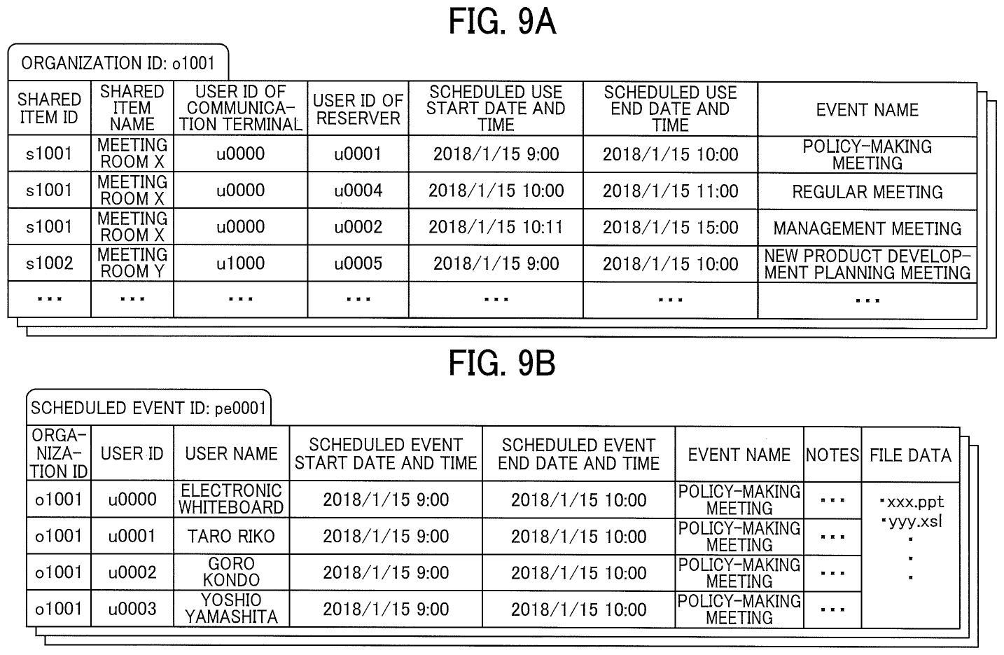

FIG. 9A is a conceptual diagram illustrating the shared item reservation management table. The storage unit 8000 includes a shared item reservation management DB 8004 implemented by the shared item reservation management table as illustrated in FIG. 9A. In the shared item reservation management table, the reservation information is managed in which respective information items are associated with each other. For each organization ID, the reservation information includes the shared item ID, the shared item name, the user ID of the communication terminal, the user ID of the reserver, the scheduled use start date and time, the scheduled use end date and time, and the event name. The scheduled use start date and time represents the date and time when the use of the shared item is scheduled to start. The scheduled use end date and time represents the date and time when the use of the shared item is scheduled to end. Each of the scheduled use start date and time and the scheduled use end date and time includes year, month, day, hour, minute, second, and time zone. In FIG. 9A, however, the information included in each of the scheduled use start date and time and the scheduled use end date and time is limited to year, month, day, hour, and minute due to space limitations.

An event management table of the present embodiment will be described.

FIG. 9B is a conceptual diagram illustrating the event management table. The storage unit 8000 includes an event management DB 8005 implemented by the event management table as illustrated in FIG. 9B. In the event management table, the schedule information is managed in which respective information items are associated with each other. In the schedule information, the organization ID, the user ID, the user name, the scheduled event start date and time, the scheduled event end date and time, and the event name are managed in association with each other for each scheduled event ID. The scheduled event start date and time represents the date and time when the execution of the event is scheduled to start. The scheduled event end date and time represents the date and time when the execution of the event is scheduled to end. Each of the scheduled event start date and time and the scheduled event end date and time includes year, month, day, hour, minute, second, and time zone. In FIG. 9B, however, the information included in each of the scheduled event start date and time and the scheduled event end date and time is limited to year, month, day, hour, and minute due to space limitations. Further, in the event management table, the file data of the material file used in the event included in the schedule information is managed in association with the scheduled event ID.

A server authentication management table of the present embodiment will be described.

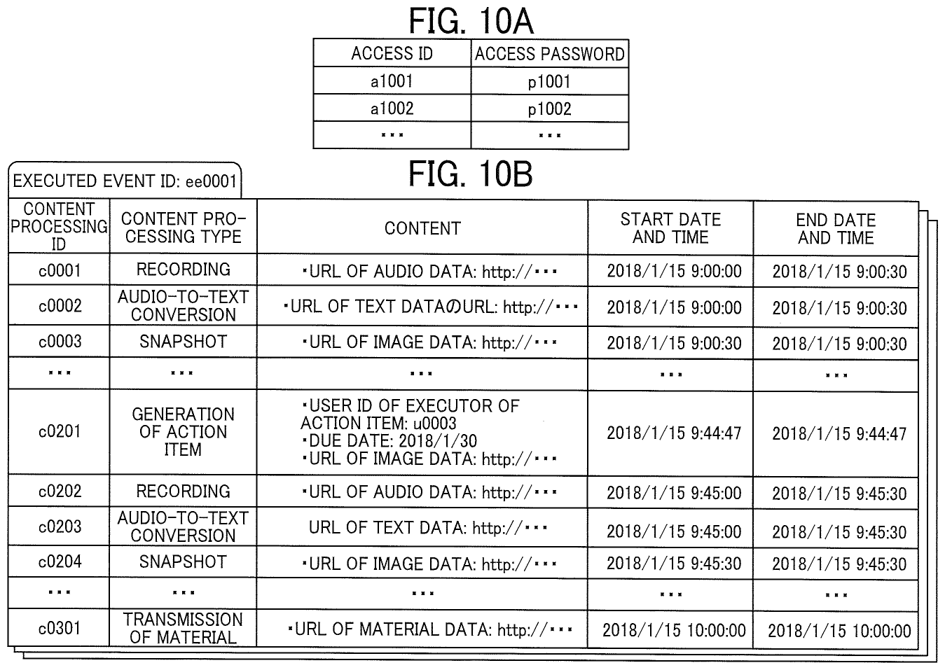

FIG. 10A is a conceptual diagram illustrating the server authentication management table. The storage unit 8000 includes a server authentication management DB 8006 implemented by the server authentication management table as illustrated in FIG. 10A. In the server authentication management table, the access ID and the access password are managed in association with each other. The access ID and the access password in the server authentication management DB 8006 are the same in concept as those managed in the access management DB 6002 of the sharing support server 6 (see FIG. 6B).

An executed event history management table of the present embodiment will be described.

FIG. 10B is a conceptual diagram illustrating the executed event history management table. The storage unit 8000 includes an executed event history management DB 8008 implemented by the executed event history management table as illustrated in FIG. 10B. In the executed event history management table, the content processing ID, the content processing type, the content, and the start date and time and the end date and time of the content processing are managed in association with each other for each executed event ID. The data managed in the executed event history management DB 8008 is partially the same as the data managed in the content management DB 6005 (see FIG. 7). The same data between the executed event history management DB 8008 and the content management DB 6005 includes the executed event ID, the content processing ID, the content processing type, and the start date and time and the end date and time of the content processing. The executed event history management DB 8008 and the content management DB 6005 use different methods of describing the storage location of the content data in the “CONTENT” field (i.e., http:// or c://). The storage locations described in the executed event history management DB 8008, however, are the same as those described in the content management DB 6005.

An executed event management table of the present embodiment will be described.

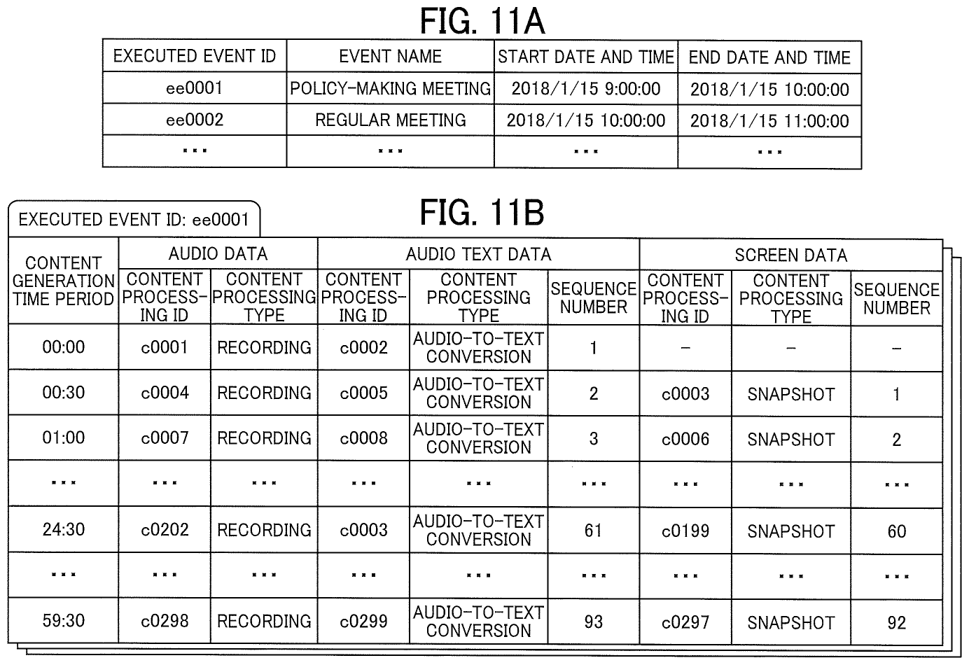

FIG. 11A is a conceptual diagram illustrating the executed event management table. The storage unit 8000 includes an executed event management DB 8009 implemented by the executed event management table as illustrated in FIG. 11A. In the executed event management table, the event name and the start date and time and the end date and time of the event are managed in association with the executed event ID. In the executed event management DB 8009, the information of actually executed events out of the events included in the schedule information managed in the event management DB 8005 (see FIG. 9B) is managed.

A related information management table of the present embodiment will be described.

FIG. 11B is a conceptual diagram illustrating the related information management table. The storage unit 8000 includes a related information management DB 8010 implemented by the related information management table as illustrated in FIG. 11B. In the related information management table, related information is managed in which information (i.e., data) items are associated with each other for each executed event ID. In the related information, the content generation time period, the audio data, the audio text data, and the screen data are managed in association with each other. The content generation time period represents the time elapsed from the start date and time of the executed event to the time of generation of the content in the event. Herein, the content generation time period is generated by the generation unit 83 based on the start date and time of the event stored in the event management DB 8005 and the start date and time and the end date and time of the content processing stored in the executed event history management DB 8008. The content generation time period is an example of time information. The audio data includes the content processing ID and the content processing type. Each of the audio text data and the screen data includes the content processing ID, the content processing type, and the sequence number. In each of the audio text data and the screen data, the sequence number represents the chronological order of generation of the content processing.

A text information management table of the present embodiment will be described.

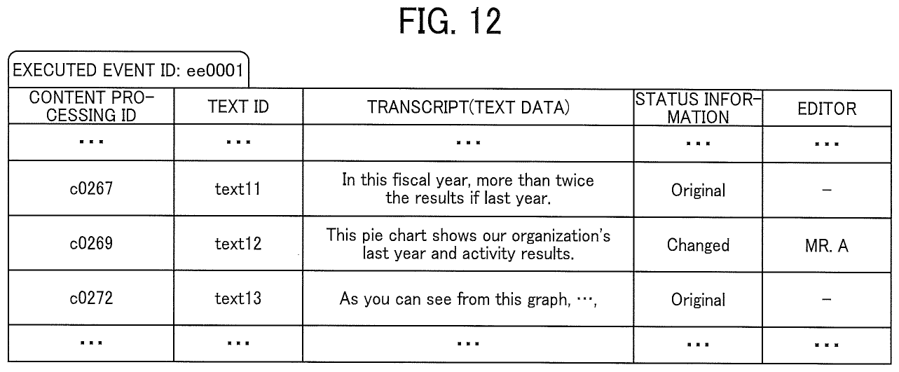

FIG. 12 is a conceptual diagram illustrating the text information management table. The storage unit 8000 includes a text information management DB 8012 implemented by the text information management table as illustrated in FIG. 12. In the text information management table, text information including the audio text data generated in the executed event is managed for each executed event ID. In the text information, the content processing ID, a text ID for identifying the text data, a transcript representing the content of the text data, status information representing the status of the text data, and the editor are associated with each other. The content processing ID is for identifying the content processing, the type of which is audio-to-text conversion in the present example. The transcript (text data) is text data representing the content associated with the corresponding content processing ID in the executed event history management DB 8008, i.e., the content processing ID associated with the transcript in the text information. The status information is information indicating whether the text data has been edited. If the text data associated with the status information has not been edited from the text data generated by the audio-to-text conversion server 9, the status information is represented as “Original,” indicating that the text data has not been edited. If the associated text data has been edited from the generated text data, the status information is represented as “Changed,” indicating that the text data has been edited. The information item “editor” includes the editor name or the editor ID of the person who has edited the text data.

The functional units of the schedule management server 8 will be described in detail. In the following description of the functional units of the schedule management server 8, the relationships between the functional units of the schedule management server 8 and major ones of the components in FIG. 4 for implementing the functional units of the schedule management server 8 will also be described.

The communication unit 81 of the schedule management server 8 illustrated in FIG. 5B is implemented by a command from the CPU 801 and the network I/F 809 illustrated in FIG. 4. The communication unit 81 transmits and receives various data (or information) to and from another terminal, apparatus, or system via the communication network N.

The authentication unit 82 is implemented by a command from the CPU 801 illustrated in FIG. 4. The authentication unit 82 executes authentication by determining whether the information transmitted from the PC 5 (i.e., the user ID, the organization ID, and the password) has previously been registered in the user authentication management DB 8001. The authentication unit 82 further executes authentication by determining whether the information transmitted from the sharing support server 6 (i.e., the access ID and the access password) has previously been registered in the server authentication management DB 8006.

The generation unit 83 is implemented by a command from the CPU 801 illustrated in FIG. 4. The generation unit 83 is a function that generates the related information registered in the related information management DB 8010.

The storage and reading unit 89 is implemented by a command from the CPU 801 and the HDD controller 805 illustrated in FIG. 4. The storage and reading unit 89 performs processes such as storing various data in the storage unit 8000 and reading the various data stored therein. The storage and reading unit 89 is an example of a storage control device.

As for a functional configuration of the audio-to-text conversion server 9, the audio-to-text conversion server 9 includes a communication unit 91, a conversion unit 93, and a storage and reading unit 99. These units are functions or functional units implemented when at least one of the components illustrated in FIG. 4 operates based on a command from the CPU 901 in accordance with a program deployed on the RAM 903 from the HD 904. The audio-to-text conversion server 9 further includes a storage unit 9000 implemented by the HD 904 illustrated in FIG. 4.

The functional units of the audio-to-text conversion server 9 will be described in detail. In the following description of the functional units of the audio-to-text conversion server 9, the relationships between the functional units of the audio-to-text conversion server 9 and major ones of the components in FIG. 4 for implementing the functional units of the audio-to-text conversion server 9 will also be described.

The communication unit 91 of the audio-to-text conversion server 9 illustrated in FIG. 5B is implemented by a command from the CPU 901 and the network I/F 909 illustrated in FIG. 4. The communication unit 91 transmits and receives various data (or information) to and from another terminal, apparatus, or system via the communication network N.

The conversion unit 93 is implemented by a command from the CPU 901 illustrated in FIG. 4. The conversion unit 93 converts the audio data received via the communication network N into text data.

The storage and reading unit 99 is implemented by a command from the CPU 901 and the HDD controller 905 illustrated in FIG. 4. The storage and reading unit 99 performs processes such as storing various data in the storage unit 9000 and reading the various data stored therein.

The IDs described above are examples of identification information. The organization ID includes the company name, the office name, the department name, and the area name, for example. The user ID includes the employee number, the driver's license number, and My Number in the Japanese social security and tax number system, for example.

A functional configuration (i.e., functional components) of the display terminal 10 will be described.

The display terminal 10 includes a communication unit 11, a receiving unit 12, a display control unit 13, and a storage and reading unit 19. These units are functions or functional units implemented when at least one of the components illustrated in FIG. 4 operates based on a command from the CPU 501 in accordance with a program deployed on the RAM 503 from the HD 504. The display terminal 10 further includes a storage unit 1000 implemented by the RAM 503 and the HD 504 illustrated in FIG. 4.

The communication unit 11 is implemented by a command from the CPU 501 and the network I/F 509 illustrated in FIG. 4. The communication unit 11 transmits and receives various data (or information) to and from another terminal, apparatus, or system via the communication network N.

The receiving unit 12 is mainly implemented by a command from the CPU 501, the keyboard 511, the mouse 512, and the display 508 with a touch panel illustrated in FIG. 4. The receiving unit 12 receives various inputs from the user.

The display control unit 13 is implemented by a command from the CPU 501 illustrated in FIG. 4. The display control unit 13 causes the display 508 to display a rendered image, or accesses the sharing support server 6 via a Web browser to display various screen data.

The storage and reading unit 19 is implemented by a command from the CPU 501 and the HD 504 illustrated in FIG. 4. The storage and reading unit 19 performs processes such as storing various data in the storage unit 1000 and reading the various data stored therein. Each time the image data and the audio data are received in the communication with the communication terminal 2 or the video conference terminal 3, the image data and the audio data stored in the storage unit 1000 are overwritten with the received image data and the received audio data. The display 508 displays the image based on the image data before being overwritten with the received image data, and the speaker 515 outputs the sound based on the audio data before being overwritten with the received audio data.

The display terminal 10 may have functions similar to those of the communication terminal 2. The functions of the display terminal 10 illustrated in FIG. 5A, however, are limited to major functions of the display terminal 10 for the convenience of explanation.

Process or operations of the present embodiment will be described below.

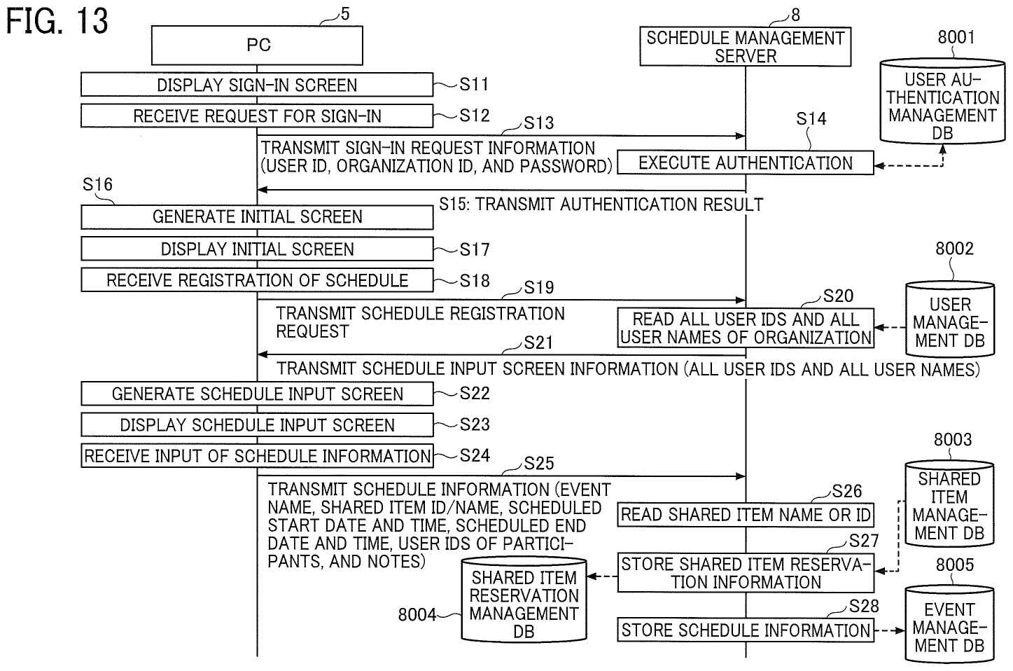

With reference to FIGS. 13 to 16, a description will be given of a process in which the user A (a reserver named Taro Riko in the present example) registers his schedule on the schedule management server 8 from one of the PC 5.

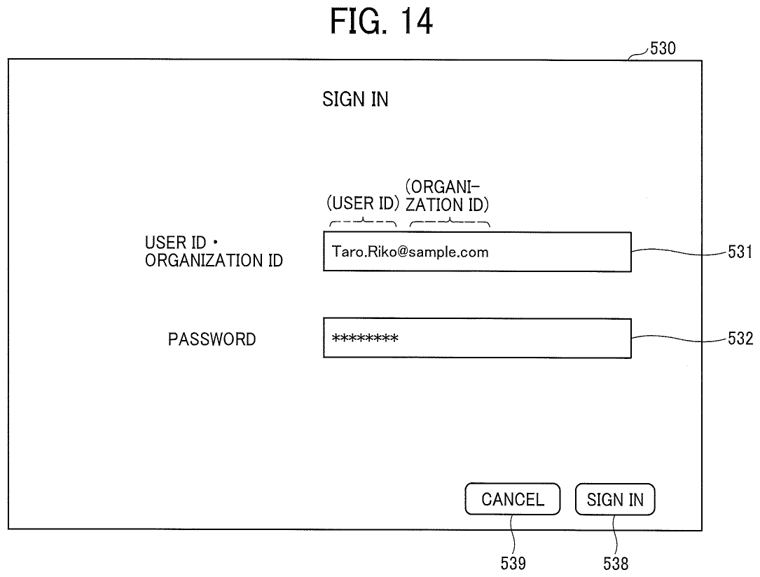

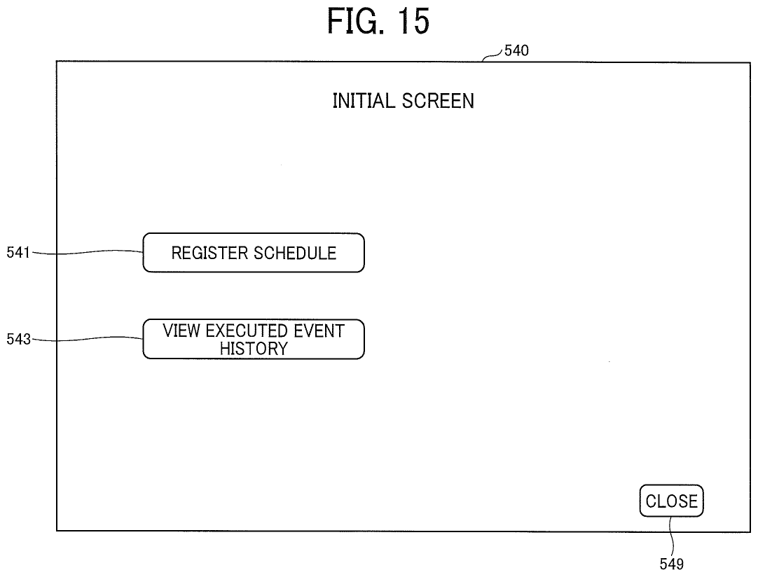

FIG. 13 is a sequence diagram illustrating a schedule registration process. FIG. 14 is a diagram illustrating a sign-in screen. FIG. 15 is a diagram illustrating an example of an initial screen displayed on the PC 5. FIG. 16 is a diagram illustrating a schedule input screen.

When the user A operates the keyboard 511 of the PC 5, for example, the display control unit 54 of the PC 5 causes the display 508 to display a sign-in screen 530 for the user A to sign in, as illustrated in FIG. 14 (step S11). The sign-in screen 530 includes an input field 531 for inputting the user ID and the organization ID of the user A, an input field 532 for inputting the password, a “SIGN IN” button 538 that is pressed to sign in, and a “CANCEL” button 539 that is pressed to cancel the sign-in. In the present example, the user ID and the organization ID form an electronic mail (email) address of the user A; a user name part of the email address represents the user ID, and a domain name part of the email address represents the organization ID. Alternatively, the input field 531 may be configured as input fields for separately inputting the user ID and the organization ID in place of the email address.

The user A then inputs his user ID and organization ID in the input field 531, inputs his password in the input field 532, and presses the “SIGN IN” button 538. Then, the receiving unit 52 of the PC 5 receives a user request for sign-in (step S12). The communication unit 51 of the PC 5 then transmits sign-in request information to the schedule management server 8 (step S13). The sign-in request information, which represents the request for sign-in, includes the information received at step S12 (i.e., the user ID, the organization ID, and the password). Thereby, the communication unit 81 of the schedule management server 8 receives the sign-in request information.

Then, the authentication unit 82 of the schedule management server 8 executes the authentication of the user A with the user ID, the organization ID, and the password (step S14). Specifically, the storage and reading unit 89 of the schedule management server 8 searches the user authentication management DB 8001 (see FIG. 8A) for a set of a user ID, an organization ID, and a password corresponding to the set of the user ID, the organization ID, and the password received at step S13. If the user authentication management DB 8001 includes the corresponding set of the user ID, the organization ID, and the password, the authentication unit 82 determines that the user A as the request source is a valid user. If the user authentication management DB 8001 does not include the corresponding set of the user ID, the organization ID, and the password, the authentication unit 82 determines that the user A is an invalid user (i.e., not a valid user). If it is determined that the user A is not a valid user, the communication unit 81 transmits a notification to the PC 5 to notify that the user A is not a valid user. It is assumed in the following description that the user A is determined to be a valid user.

The communication unit 81 then transmits an authentication result to the PC 5 (step S15). Thereby, the communication unit 51 of the PC 5 receives the authentication result.

If the authentication result received at step S15 indicates that the user A is a valid user, the generation unit 56 of the PC 5 generates an initial screen 540 as illustrated in FIG. 15 (step S16). Then, the display control unit 54 of the PC 5 causes the display 508 to display the initial screen 540 as illustrated in FIG. 15 (step S17). The initial screen 540 includes a “REGISTER SCHEDULE” button 541 that is pressed to register a schedule and a “VIEW EXECUTED EVENT HISTORY” button 543 that is pressed to view an executed event history. If the user A presses the “REGISTER SCHEDULE” button 541 in this case, the receiving unit 52 receives the registration of the schedule (step S18). Then, the communication unit 51 transmits a schedule registration request to the schedule management server 8 (step S19). Thereby, the communication unit 81 of the schedule management server 8 receives the schedule registration request.

Then, the storage and reading unit 89 of the schedule management server 8 performs a search through the user management DB 8002 (see FIG. 8B) by using the organization ID received at step S13 as a search key, to thereby read all user IDs and all user names corresponding to the organization ID (step S20). The communication unit 81 then transmits schedule input screen information to the PC 5 (step S21). The schedule input screen information includes the all user IDs and the all user names read at step S20. The all user names include the name of the reserver, i.e., the user A who has input the information for sign-in at step S12. Thereby, the communication unit 51 of the PC 5 receives the schedule input screen information.

In the PC 5, the generation unit 56 then generates a schedule input screen 550 with the schedule input screen information received at step S21 (step S22). Then, the display control unit 24 of the PC 5 causes the display 508 to display the schedule input screen 550 as illustrated in FIG. 16 (step S23).

The schedule input screen 550 includes input fields 551, 552, 553, 554, and 555, a display area 556, a selection menu 557, an “OK” button 558, and a “CANCEL” button 559. The input field 551 is used to input the event name. The input field 552 is used to input the shared item ID or the shared item name. The input field 553 is used to input the scheduled start date and time when the execution of the event (i.e., the use of the shared item) is scheduled to start. The input field 554 is used to input the scheduled end date and time when the execution of the event (i.e., the use of the shared item) is scheduled to end. The input field 555 is used to input notes such as an agenda. The display area 556 is used to display the name of the reserver. The selection menu 557 is used to select the names of the other participants than the reserver. The “OK” button 558 is pressed to register a reservation. The “CANCEL” button 559 is pressed to cancel the input information or the information being input. The name of the reserver is the name of the user A who has input the information for sign-in to the PC 5 at step S12. The schedule input screen 550 further displays a mouse pointer p1.

The input field 552 may be used to input an email address. Further, if the name of the shared item is selected in the selection menu 557, the shared item is also added to the other participants.

Then, if the user A inputs particular information in the input fields 551 to 555, selects the names (i.e., user names) of the users desired to participate in the event from the selection menu 557 by using the mouse pointer p1, and presses the “OK” button 558, the receiving unit 52 receives the input of the schedule information (step S24). The communication unit 51 then transmits the schedule information to the schedule management server 8 (step S25). The schedule information includes the event name, the shared item ID (or the shared item name), the scheduled start date and time, the scheduled end date and time, the user IDs of the participants, and the notes. If the shared item ID is input in the input field 552 of the schedule input screen 550, the shared item ID is transmitted to the schedule management server 8. If the shared item name is input in the input field 552, the shared item name is transmitted to the schedule management server 8. On the schedule input screen 550, the user names are selected from the selection menu 557. Since the user IDs are also received at step S21, the user IDs corresponding to the user names are transmitted to the schedule management server 8. Thereby, the communication unit 81 of the schedule management server 8 receives the schedule information.

Then, the schedule management server 8 performs a search through the shared item management DB 8003 (see FIG. 8C) by using the shared item ID (or the shared item name) received at step S25 as a search key, to thereby read the shared item name (or the shared item ID) corresponding to the received shared item ID (or the received shared item name) (step S26).

Then, the storage and reading unit 89 stores the reservation information in the shared item reservation management DB 8004 (see FIG. 9A) (step S27). In this case, the storage and reading unit 89 adds one record of reservation information to the shared item reservation management table of the shared item reservation management DB 8004 managed by a previously registered scheduler. The reservation information is configured based on the schedule information received at step S25 and the shared item name (or the shared item ID) read at step S26. The scheduled use start date and time in the shared item reservation management DB 8004 corresponds to the scheduled start date and time in the schedule information. Further, the scheduled use end date and time in the shared item reservation management DB 8004 corresponds to the scheduled end date and time in the schedule information.

The storage and reading unit 89 further stores schedule information in the event management DB 8005 (see FIG. 9B) (step S28). In this case, the storage and reading unit 89 adds one record of schedule information to the event management table of the event management DB 8005 managed by a previously registered scheduler. The added schedule information is configured based on the schedule information received at step S25. The scheduled event start date and time in the event management DB 8005 corresponds to the scheduled start date and time in the received schedule information. Further, the scheduled event end date and time in the event management DB 8005 corresponds to the scheduled end date and time in the received schedule information.

According to the above-described process, the user A is able to register his schedule on the schedule management server 8. In the process described above with FIGS. 13 to 16, the schedule is registered with the PC 5. Alternatively, the user operating the communication terminal 2, the video conference terminal 3, or the vehicle navigation system 4 may register a schedule through a process similar to the above-described process.

An event starting process of the present embodiment will be described. Specifically, a process of having a meeting with the other participants by using the communication terminal 2 in the meeting room X reserved by the user A (the reserver named Taro Riko in the present example) will be described with reference to FIGS. 17 to 25.

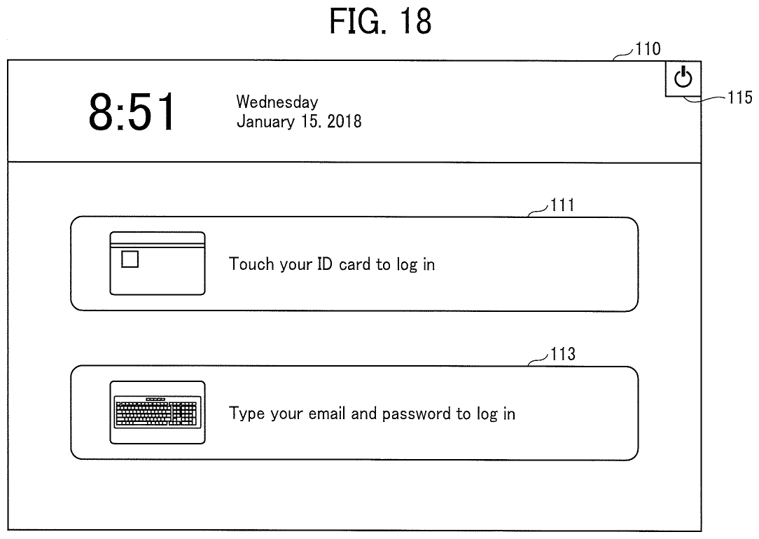

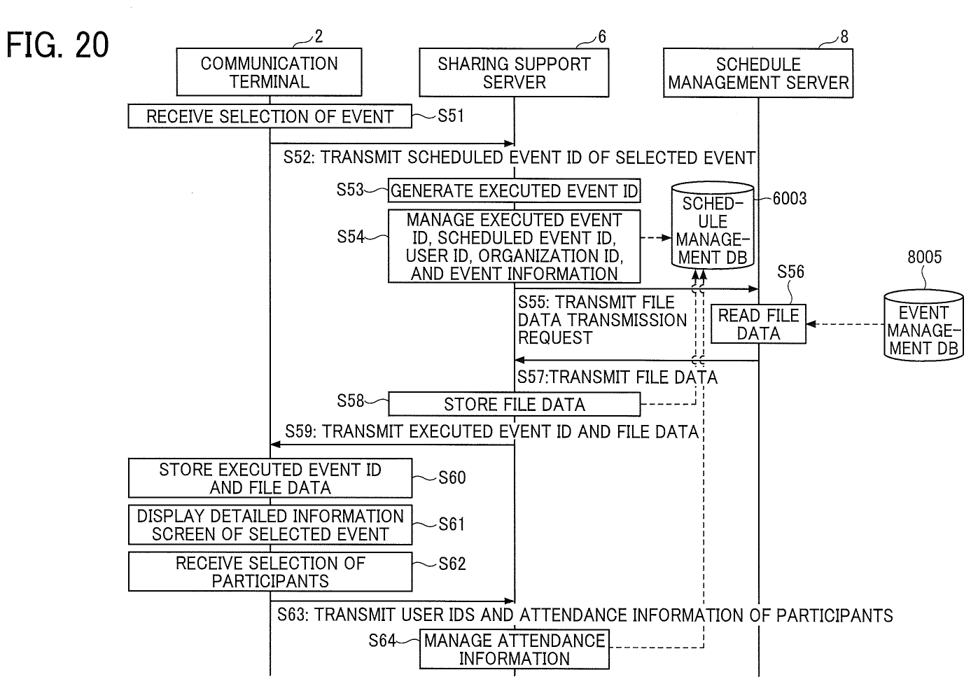

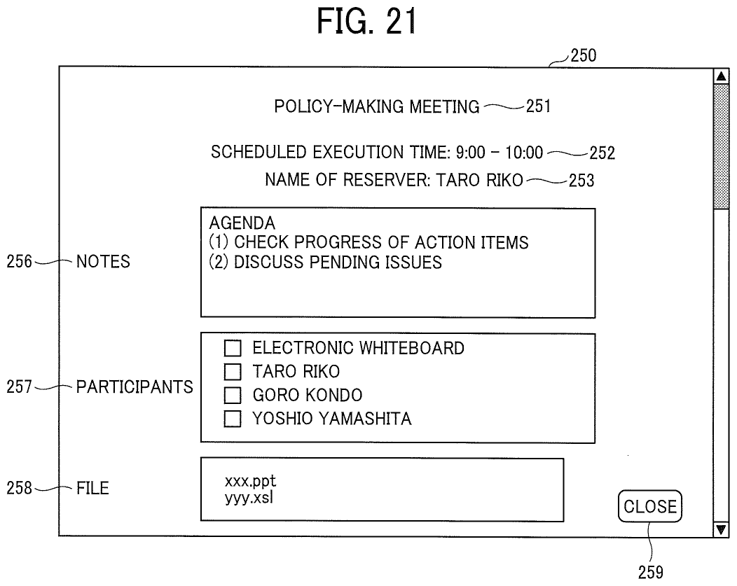

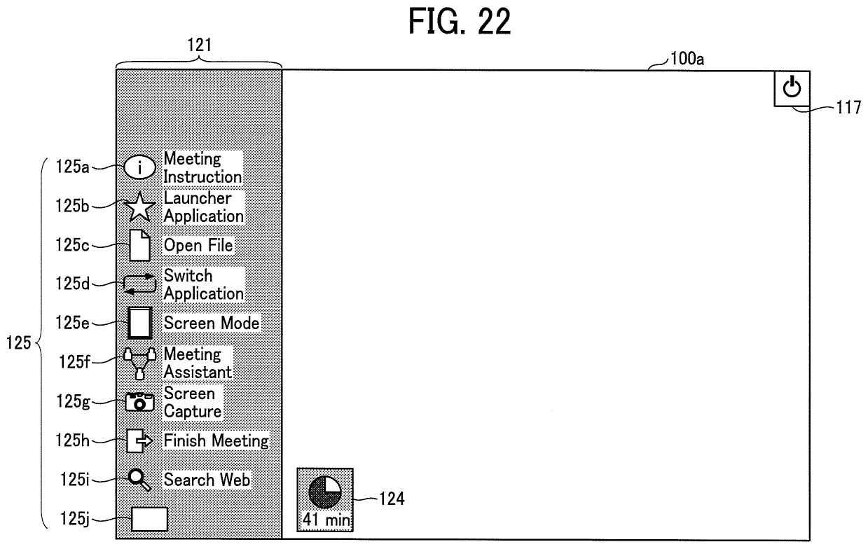

FIGS. 17 and 20 are sequence diagrams illustrating the event starting process. FIG. 18 is a diagram illustrating a sign-in screen displayed on the communication terminal 2. FIG. 19 is a diagram illustrating a shared item reservation list screen. FIG. 21 is a diagram illustrating a detailed event information screen. FIG. 22 is a diagram illustrating a display screen displayed on the communication terminal 2 after the sign-in.

When the user A presses a power switch of the communication terminal 2, the receiving unit 22 of the communication terminal 2 receives a power-on operation (or the launch of an application) performed by the user A (step S31). Then, as illustrated in FIG. 18, the display control unit 24 of the communication terminal 2 controls the display 508 to display a sign-in screen 110 for the user A to sign in (step S32). The sign-in screen 110 includes selection icons 111 and 113 and a power icon 115 (or an application end button). The selection icon 111 is pressed when the user A signs in with his integrated circuit (IC) card. The selection icon 113 is pressed when the user A signs in by inputting his email address (i.e., the user ID and the organization ID) and his password. The power icon 115 is pressed when the user A powers off the communication terminal 2 without signing in.

Then, if the user A presses the selection icon 113 and inputs his email address and his password, the receiving unit 22 receives a user request for sign-in (step S33). Then, the communication unit 21 transmits the sign-in request information to the sharing support server 6 (step S34). The sign-in request information representing the sign-in request includes the information received at step S33 (i.e., the user ID, the organization ID, and the password), time zone information of the country or region in which the communication terminal 2 is installed, a user ID of the communication terminal 2, the organization ID, and the password. Thereby, the communication unit 61 of the sharing support server 6 receives the sign-in request information.

Then, the authentication unit 62 of the sharing support server 6 executes the authentication of the user A with the user ID, the organization ID, and the password of the user A received at step S34 (step S35). Specifically, using the user ID, the organization ID, and the password of the user A received at step S34 as a search key, the storage and reading unit 69 of the sharing support server 6 searches the user authentication management DB 6001 (see FIG. 6A) for a set of a user ID, an organization ID, and a password corresponding to the received set of the user ID, the organization ID, and the password of the user A. If the user authentication management DB 6001 includes the corresponding set of the user ID, the organization ID, and the password, the authentication unit 62 determines that the user A as the request source is a valid user. If the user authentication management DB 6001 does not include the corresponding set of the user ID, the organization ID, and the password, the authentication unit 62 determines that the user A as the request source is an invalid user (i.e., not a valid user). If it is determined that the user A is not a valid user, the communication unit 61 transmits a notification to the communication terminal 2 to notify that the user A is not a valid user. It is assumed in the following description that the user A is determined to be a valid user.

Then, the storage and reading unit 69 of the sharing support server 6 performs a search through the access management DB 6002 (see FIG. 6B) by using the organization ID of the user A received at step S34 as a search key, to thereby read the access ID and the access password corresponding to the organization ID (step S36).

Then, the communication unit 61 transmits reservation request information and schedule request information to the schedule management server 8 (step S37). The reservation request information represents the request for the reservation information of the shared item. The schedule request information represents the request for the schedule information of the user A. Each of the reservation request information and the schedule request information includes the time zone information, the user ID of the communication terminal 2, and the organization ID received at step S34 and the access ID and the access password read at step S36. Thereby, the communication unit 81 of the schedule management server 8 receives the reservation request information and the schedule request information.

Then, the authentication unit 82 of the schedule management server 8 executes the authentication of the sharing support server 6 with the access ID and the access password (step S38). Specifically, the storage and reading unit 89 of the schedule management server 8 searches the server authentication management DB 8006 (see FIG. 10A) for a pair of an access ID and an access password corresponding to the pair of the access ID and the access password received at step S37. If the server authentication management DB 8006 includes the corresponding pair of the access ID and the access password, the authentication unit 82 determines that the sharing support server 6 as the request source is a valid accessing party. If the server authentication management DB 8006 does not include the corresponding pair of the access ID and the access password, the authentication unit 82 determines that the sharing support server 6 as the request source is an invalid accessing party (i.e., not a valid accessing party). If it is determined that the sharing support server 6 is not a valid accessing party, the communication unit 81 transmits a notification to the sharing support server 6 to notify that the sharing support server 6 is not a valid accessing party. It is assumed in the following description that the sharing support server 6 is determined to be a valid accessing party.

Using the user ID of the communication terminal 2 received at step S37 as a search key, the storage and reading unit 89 of the schedule management server 8 performs a search through the shared item reservation management DB 8004 (see FIG. 9A) managed by the scheduler, to thereby read the reservation information corresponding to the user ID (step S39). In the present example, the storage and reading unit 89 reads the reservation information in which the scheduled use start date and time is today.

Using the user ID of the communication terminal 2 received at step S37 as a search key, the storage and reading unit 89 further performs a search through the event management DB 8005 (see FIG. 9B) managed by the scheduler, to thereby read the schedule information corresponding to the user ID (step S40). In the present example, the storage and reading unit 89 reads the schedule information in which the scheduled event start date and time is today. If the schedule management server 8 is located in a country or region different from that of the communication terminal 2, the time zone is adjusted based on the time zone information in accordance with the country or region in which the communication terminal 2 is installed.

Then, the communication unit 81 transmits the reservation information read at step S39 and the schedule information read at step S40 to the sharing support server 6 (step S41). Thereby, the communication unit 61 of the sharing support server 6 receives the reservation information and the schedule information.

Then, the creation unit 63 of the sharing support server 6 creates a reservation list based on the reservation information and the schedule information received at step S41 (step S42). The communication unit 61 then transmits reservation list information to the communication terminal 2 (step S43). The reservation list information represents the contents of the reservation list. Thereby, the communication unit 21 of the communication terminal 2 receives the reservation list information.

In the communication terminal 2, the display control unit 24 then causes the display 508 to display a reservation list screen 230 as illustrated in FIG. 19 (step S44). The reservation list screen 230 includes display areas 231 and 232. The display area 231 displays the name of the shared item (the name of a place in the present example). The display area 232 displays the date and time of today. The reservation list screen 230 further displays event information items 235, 236, 237, and so forth, each representing an event for which the shared item (the meeting room X in the present example) is scheduled to be used today. In each of the event information items 235, 236, 237, and so forth, the scheduled use start and end times of the shared item, the event name, and the name (i.e., reserver name) of the reserver who has reserved the shared item are included for the corresponding event. The event information items 235, 236, 237, and so forth include start buttons 235s, 236s, 237s, and so forth, respectively, each of which is pressed when the user A specifies the event to start.

Then, if the user A presses the start button 235s in FIG. 20, for example, the receiving unit 22 of the communication terminal 2 receives the user selection of the event represented by the event information item 235 (step S51). Then, the communication unit 21 of the communication terminal 2 transmits to the sharing support server 6 the scheduled event ID representing the scheduled event selected at step S51 (step S52). The process of step S52 is a process of requesting the transmission of the executed event identification information. Thereby, the communication unit 61 of the sharing support server 6 receives the scheduled event ID of the selected event.

In the sharing support server 6, the generation unit 64 then generates a unique executed event ID (step S53). Then, the storage and reading unit 69 of the sharing support server 6 manages the executed event ID generated at step S53, the scheduled event ID received at step S52, the user ID and the organization ID of the reserver, and the event information item 235 in association with each other (step S54).

The user ID and the organization ID of the reserver and the event information item 235 are the IDs and information item based on the reservation information and the schedule information received at step S41. At this stage, there is no input in the “ATTENDANCE” field of the reservation management table (see FIG. 6C).

Then, in the sharing support server 6, the communication unit 61 transmits file data transmission request information to the schedule management server 8 (step S55). The file data transmission request information represents the request to transmit the file data registered in the schedule management server 8. The file data transmission request information includes the scheduled event ID received at step S52, the user ID of the communication terminal 2 and the organization ID received at step S34, and the access ID and the access password read at step S36. Thereby, the communication unit 81 of the schedule management server 8 receives the file data transmission request information.

Then, the storage and reading unit 89 of the schedule management server 8 performs a search through the event management DB 8005 (see FIG. 9B) by using the scheduled event ID received at step S55 as a search key, to thereby read the file data associated with the scheduled event ID (step S56). Then, the communication unit 81 transmits the file data read at step S56 to the sharing support server 6 (step S57). Thereby, the communication unit 61 of the sharing support server 6 receives the file data.

Then, the storage and reading unit 69 of the sharing support server 6 stores and manages the file data received at step S57 in the schedule management DB 6003 (see FIG. 6C) in association with the scheduled event ID received at step S52 and the executed event ID generated at step S53 (step S58).

The communication unit 61 then transmits the executed event ID generated at step S53 and the file data received at step S57 to the communication terminal 2 (step S59). Thereby, the communication unit 21 of the communication terminal 2 receives the executed event ID and the file data.

In the communication terminal 2, the storage and reading unit 29 then stores the executed event ID and the file data in the storage unit 2000 (step S60). In this step, the file data transmitted from the sharing support server 6 is stored in a particular storage area in the storage unit 2000. The communication terminal 2 accesses the particular storage area during the execution of the event, and the display control unit 24 of the communication terminal 2 causes the display 508 to display the file data stored in the particular storage area. Herein, the particular storage area is a temporary data storage location provided for each ongoing event, and is identified by any desired path (character string) representing a location in the storage unit 2000. The particular storage area is not necessarily provided in the communication terminal 2, and may be provided in an external storage device connected to the communication terminal 2 or in a local server located in an on-premise environment and communicable with the communication terminal 2, for example.

Then, the display control unit 24 causes the display 508 to display a detailed information screen 250 of the selected event, as illustrated in FIG. 21 (step S61). The detailed information screen 250 of the event includes display areas 251, 252, 253, 256, 257, and 258. The display area 251 displays the event name. The display area 252 displays the scheduled execution time (i.e., the scheduled start time and the scheduled end time) of the event. The display area 253 displays the name of the reserver. The display area 256 displays the contents of the notes. The display area 257 displays the names of prospective participants. The display area 258 displays identification information (e.g., a file name) for identifying the file data stored in the particular storage area of the storage unit 2000. The display area 257 displays, as well as the names of the reserver and the other selected participants illustrated in FIG. 16, checkboxes corresponding to the names of the prospective participants to tick the people who are actually participating in the meeting. The display area 258 displays, as well as the file name of the file data downloaded from the sharing support server 6 and stored in the particular storage area of the storage unit 2000, the file name of file data being downloaded from the sharing support server 6. The detailed information screen 250 of the event further includes, in a lower-right corner thereof, a “CLOSE” button 259 that is pressed to close the detailed information screen 250.

Then, when the user A ticks the checkboxes corresponding to the names of the actually participating participants (i.e., users) out of the prospective participants and presses the “CLOSE” button 259, the receiving unit 22 of the communication terminal 2 receives the user selection of the participants (step S62). The communication unit 21 of the communication terminal 2 then transmits the user IDs and the attendance information of the prospective participants to the sharing support server 6 (step S63). Thereby, the communication unit 61 of the sharing support server 6 receives the user IDs and the attendance information of the prospective participants.

The sharing support server 6 then stores and manages the attendance information in the “ATTENDANCE” field of the schedule management DB 6003 (step S64), which has been blank until this step.

With the above-described process, the user A starts the event (a policy-making meeting in the present example) with the shared item (the meeting room X in the present example) and the communication terminal 2. When the event starts, the display control unit 24 of the communication terminal 2 causes the display 508 to display a display screen 100a as illustrated in FIG. 22.

FIG. 22 is a diagram illustrating the display screen 100a displayed on the communication terminal 2 when the event starts. The display screen 100a illustrated in FIG. 22 includes a menu bar 121, time information 124, and a power icon 117. The time information 124 represents the time elapsed from the start of the event or the time left to the end of the event. The power icon 117 is pressed to turn off the power supply of the communication terminal 2. The menu bar 121 includes a plurality of operation icons 125 (i.e., operation icons 125a, 125b, 125c, 125d, 125e, 125f, 125g, 125h, 125i, and 125j) that are selected (i.e., pressed) to perform various processes during the execution of the event. The operation icon 125a is selected (i.e., pressed) to view detailed information of the ongoing event. The operation icon 125b is selected (i.e., pressed) to launch various external applications. The operation icon 125c is selected (i.e., pressed) to view the file data stored in the particular storage area of the storage unit 2000. The operation icon 125d is selected (i.e., pressed) to switch the display of an application display screen of a running external application. The operation icon 125e is selected (i.e., pressed) to change the screen size of the application display screen of the external application. The operation icon 125f is selected (i.e., pressed) to perform various operations related to the ongoing event. The operation icon 125g is selected (i.e., pressed) to capture the display screen 100a displayed on the display 508. The operation icon 125h is selected (i.e., pressed) to end the ongoing event. The operation icon 125i is selected (i.e., pressed) to launch a browser application to perform a search with a browser. The operation icon 125j is selected (i.e., pressed) to input text or a numerical value, for example.

The various icons included in the display screen 100a displayed on the communication terminal 2 are examples of a receiving area. The receiving area is not limited to the image such as an icon or a button, and may be text such as “CHANGE” or the combination of an image and text. The image in this case is not limited to a symbol or an object, and may be any image viewable to the user, such as an illustration or a pattern. Further, the selection (i.e., pressing) of the various icons is an example of an operation performed on the various icons. The operation performed on the various icons includes an input operation performed on the display 508 with the keyboard 511 and the mouse 512, for example.

The user A is able to have a meeting in the meeting room X with the communication terminal 2. For example, if the user A of the communication terminal 2 presses the operation icon 125c, the receiving unit 22 of the communication terminal 2 receives the user selection of the operation icon 125c, and the display control unit 24 of the communication terminal 2 causes the display 508 to display the file data of the material file stored in the particular storage area of the storage unit 2000. The display control unit 24 may cause the display 508 to display, as well as the file data received at step S59, file data previously stored in the storage unit 2000 or file data newly generated in the started and ongoing event. In this case, the storage and reading unit 29 of the communication terminal 2 stores the file data generated or updated in the started and ongoing event in the particular storage area of the storage unit 2000.

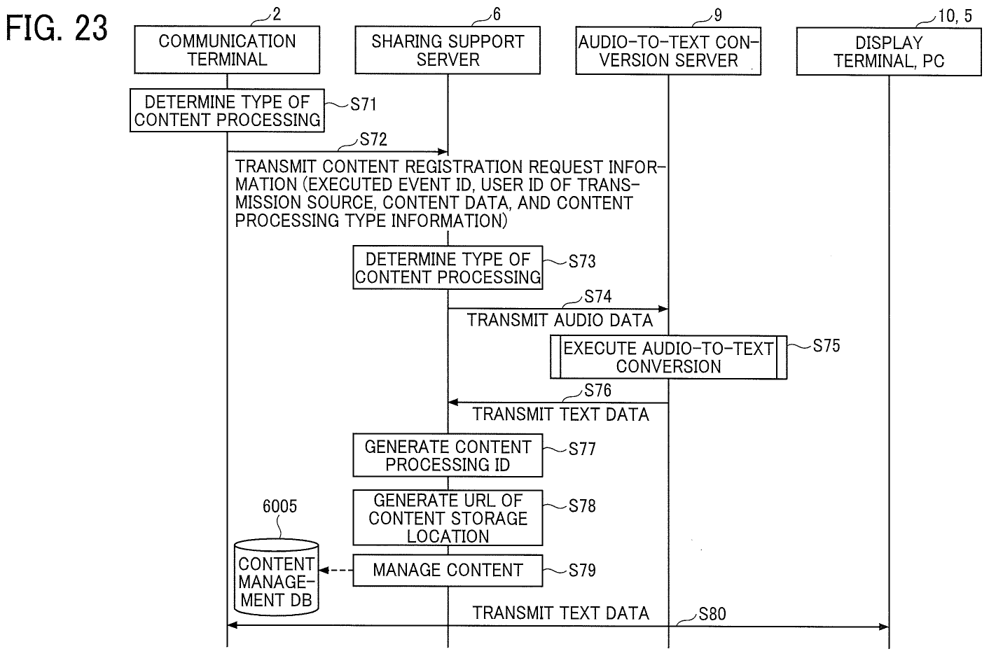

A process of registering the executed event history will be described with FIGS. 23 to 25.

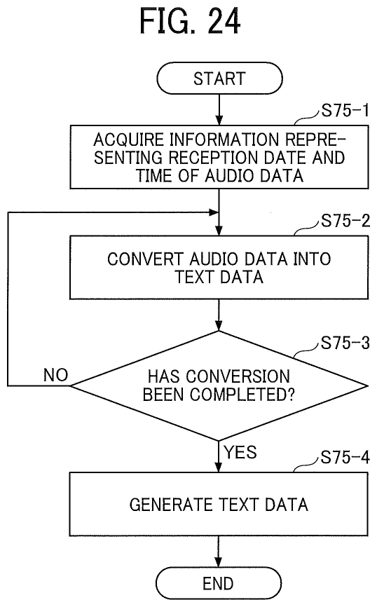

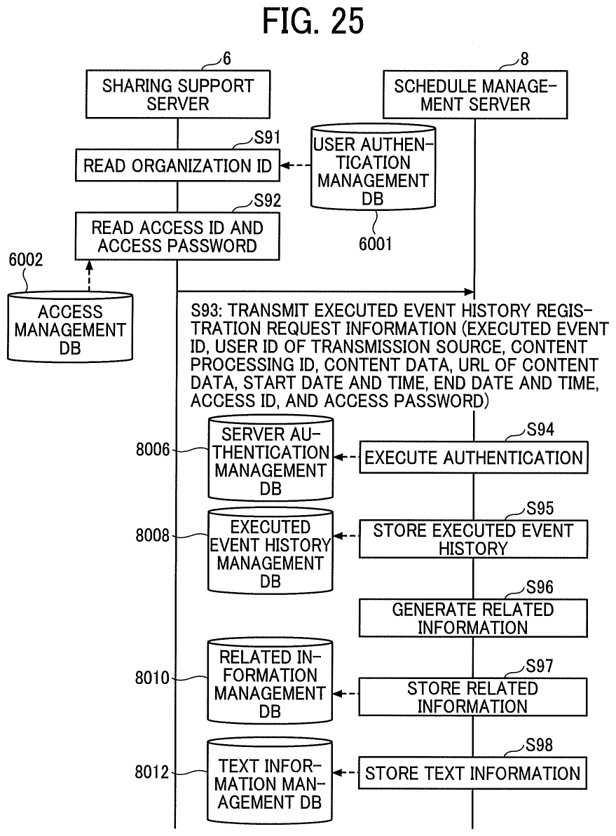

FIGS. 23 and 25 are sequence diagrams illustrating the process of registering the executed event history. FIG. 24 is a flowchart illustrating an audio-to-text conversion process.

The determination unit 25 of the communication terminal 2 first determines the type of the content processing in the started and ongoing event (step S71). Specifically, if the content is the audio data generated through the recording by the image and audio processing unit 23, the determination unit 25 determines the type of the content processing as recording. If the content is the image data acquired through the snapshot (i.e., capture) by the image and audio processing unit 23, the determination unit 25 determines the type of the content processing as snapshot. If the content is the material file data transmitted by the communication unit 21, the determination unit 25 determines the type of the content processing as the transmission of the material.

Then, the communication unit 21 transmits registration request information to the sharing support server 6 (step S72). The registration request information represents the request to register the generated content. In this case, each time the content is generated, the communication unit 21 automatically transmits the registration request information to the sharing support server 6. The registration request information includes the executed event ID, the user ID of the transmission source of the content, the content data, and the content processing type information. Thereby, the communication unit 61 of the sharing support server 6 receives the registration request information.

Based on the content processing type information included in the registration request information received by the communication unit 61, the determination unit 65 of the sharing support server 6 determines the type of the received content processing (step S73). Then, if the determination unit 65 determines the type of the content processing as recording, the communication unit 61 transmits the audio data, which is the content data, to the audio-to-text conversion server 9 (step S74). Thereby, the communication unit 91 of the audio-to-text conversion server 9 receives the audio data. If the type of the content processing is determined to be other than recording, the sharing support server 6 proceeds to the process of step S77 without executing the processes of steps S74 to S76.

The conversion unit 93 of the audio-to-text conversion server 9 converts the audio data received by the communication unit 91 into text data (step S75).

The audio-to-text conversion process of the audio-to-text conversion server 9 will be described with FIG. 24.

The conversion unit 93 first acquires information representing the date and time of reception of the audio data by the communication unit 91 (step S75-1). The information acquired at step S75-1 may be information representing the date and time of reception of the audio data by the sharing support server 6 or the date and time of transmission of the audio data by the sharing support server 6. In this case, the communication unit 91 of the audio-to-text conversion server 9 receives, at step S74, the audio data transmitted from the sharing support server 6 and the information representing the above-described date and time.

Then, the conversion unit 93 executes the process of converting the audio data received by the communication unit 91 into text data (step S75-2). Then, when the process of converting the audio data into text data is completed (YES at step S75-3), the conversion unit 93 proceeds to the process of step S75-4. The conversion unit 93 repeats the process of step S75-2 until the process of converting the audio data into text data is completed. When the audio data received by the communication unit 91 is converted into a particular amount of text, the conversion unit 93 determines that the process of converting the audio data into text data is completed. For example, when the audio data is converted into one sentence of text, the conversion unit 93 determines that the process of converting the audio data into text data is completed. The conversion unit 93 then generates the text data converted from the audio data (step S75-4). Thereby, the audio-to-text conversion server 9 converts the audio data transmitted from the sharing support server 6 into the text data. Since the audio-to-text conversion server 9 receives, as necessary, the audio data transmitted from the sharing support server 6, the audio-to-text conversion server 9 repeatedly executes the process illustrated in FIG. 24.

Referring back to FIG. 23, the description of the process of registering the executed event history will continue.

The communication unit 91 transmits the text data converted by the conversion unit 93 to the sharing support server 6 (step S76). In this step, the communication unit 91 transmits, as well as the text data, the information representing the date and time acquired at step S75-1 to the sharing support server 6.

Then, the generation unit 64 of the sharing support server 6 generates a unique content processing ID for identifying the content processing occurred in the event (step S77). The generation unit 64 further generates the URL of the content data representing the content (step S78). Then, for each executed event ID received at step S72, the storage and reading unit 69 of the sharing support server 6 manages, in the content management DB 6005 (see FIG. 7), the content processing type, the start date and time and the end date and time of the content processing, the content processing ID generated at step S77, and the URL of the storage location of the content generated at step S78 in association with each other (step S79).

If the content processing type is audio-to-text conversion, the start date and time and the end date and time of the content processing correspond to the date and time of conversion of the audio data into the text data. Herein, the date and time of conversion of the audio data into the text data corresponds to the date and time of transmission of the audio data by the communication unit 61 of the sharing support server 6 and the date and time of reception of the text data by the communication unit 61 of the sharing support server 6. Alternatively, the date and time of conversion of the audio data into the text data may correspond to the date and time of reception of the audio data by the communication unit 91 of the audio-to-text conversion server 9 and the date and time of transmission of the text data by the communication unit 91 of the audio-to-text conversion server 9. Further, if the content processing type is audio-to-text conversion, the start date and time and the end date and time of the content processing may be the same as the start date and time and the end date and time of the content processing related to the audio data that is to be converted into text data.

Further, if the content processing type is recording, snapshot, or transmission of material, the start date and time and the end date and time of the content processing correspond to the date and time of reception of the content data (e.g., the audio data, the image data, or the file data) by the communication unit 61 of the sharing support server 6. Alternatively, if the content processing type is recording, snapshot, or transmission of material, the start date and time and the end date and time of the content processing may correspond to the date and time of transmission of the content data by the communication unit 21 of the communication terminal 2. Further, if the content processing type is recording, the start date and time and the end date and time of the content processing may correspond to the start date and time and the end date and time of the recording by the image and audio processing unit 23. Further, if the content processing type is snapshot, the start date and time and the end date and time of the content processing may correspond to the date and time of snapshot (i.e., capture) by the image and audio processing unit 23.

The communication unit 61 further transmits the text data to the communication terminal 2 and to the display terminal 10 and the PC 5, with which the session is established (step S80). Thereby, the text data converted from the audio data is displayed in real time on the communication terminal 2 and the display terminal 10.

Then, as illustrated in FIG. 25, the storage and reading unit 69 of the sharing support server 6 performs a search through the user authentication management DB 6001 (see FIG. 6A) by using the user ID received at step S72 as a search key, to thereby read the organization ID corresponding to the user ID (step S91).

The storage and reading unit 69 then performs a search through the access management DB 6002 (see FIG. 6B) by using the organization ID read at step S91 as a search key, to thereby read the access ID and the access password corresponding to the organization ID (step S92).

Then, the communication unit 61 transmits executed event history registration request information to the schedule management server 8 (step S93). The executed event history registration request information represents the request to register the content data. The executed event history registration request information includes the executed event ID, the user ID of the transmission source of the content, and the content data received at step S72, the content processing ID generated at step S77, the URL of the content data generated at step S78, the access ID and the access password read at step S92, and the start date and time and the end date and time of the content processing. Thereby, the communication unit 81 of the schedule management server 8 receives the executed event history registration request information.

Then, in the schedule management server 8, the authentication unit 82 executes the authentication of the sharing support server 6 with the access ID and the access password (step S94). This authentication process is similar to that of step S38, and thus description thereof will be omitted here. It is assumed in the following description that the sharing support server 6 is authenticated.

Then, the storage and reading unit 89 of the schedule management server 8 stores and manages the various data (or information) received at step S93 in the executed event history management DB 8008 (see FIG. 10B) (step S95). The storage and reading unit 89 stores the various data (or information) in the executed event history management DB 8008 in association with the executed event ID received at step S93. Thereby, the schedule management server 8 manages data similar in content to the data managed in the sharing support server 6.

Further, the generation unit 83 of the schedule management server 8 generates the related information in which the content data received at step S93 is associated with each content generation time period (step S96). The content generation time period included in the related information is generated with the scheduled event start date and time stored in the event management DB 8005 and the start date and time and the end date and time of the content processing stored in the executed event history management DB 8008. That is, the content generation time period represents the time elapsed from the event start date and time to the time of generation of the content in the executed event. Then, the storage and reading unit 89 of the schedule management server 8 stores and manages the related information generated by the generation unit 83 in the related information management DB 8010 (see FIG. 11B) in association with the executed event ID received at step S93 (step S97). Thereby, the schedule management server 8 manages different content processing types of content data in association with the respective content generation time periods.

The storage and reading unit 89 of the schedule management server 8 then stores and manages the text information, which includes the text data received at step S93, in the text information management DB 8012 (see FIG. 12) in association with the executed event ID received at step S93 (step S98). Specifically, the generation unit 83 generates the text information including the text data and the content processing ID received at step S93, the text ID for identifying the text data received at step S93, and the status information. Then, the storage and reading unit 89 stores the text information generated by the generation unit 83 in the text information management DB 8012 in association with the executed event ID received at step S93. In this case, the status information included in the text information is represented as “Original,” indicating that the text data associated with the status information has not been edited.

With the above-described process, the communication terminal 2 transmits the executed event ID of the ongoing event and the content generated in the event to the schedule management server 8. Further, for each executed event ID, the schedule management server 8 stores the received content in the executed event history management DB 8008. According to the communication system 1, therefore, the content generated in the executed event is stored for each event.

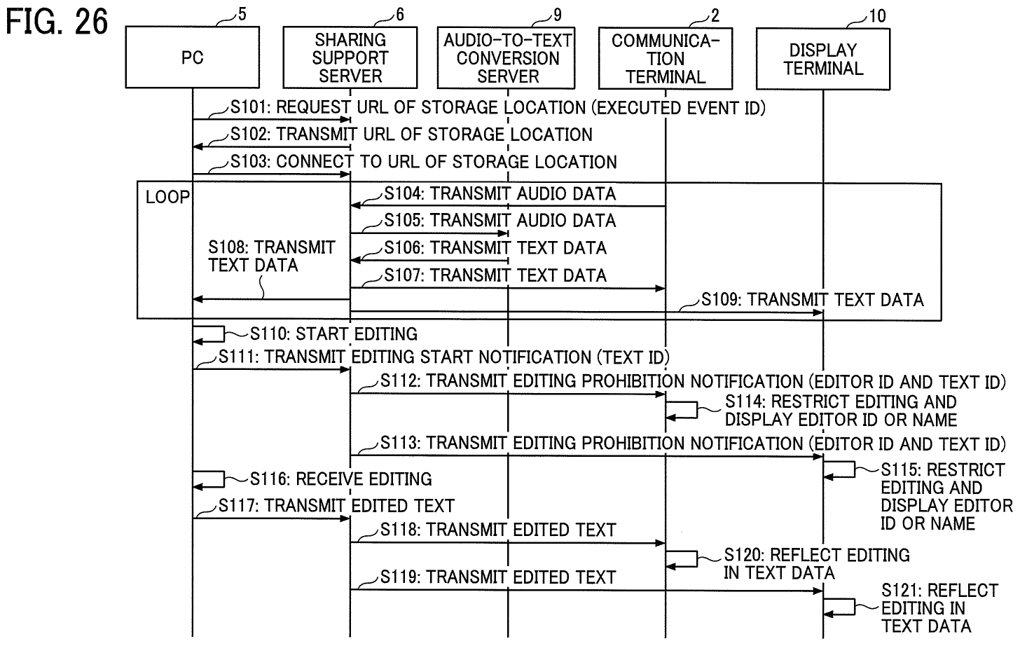

A process of correcting the text data in real time will be described with reference to FIGS. 26 to 32.

FIG. 26 is a sequence diagram illustrating a process in which the PC 5 receives the editing of the text data and transmits the contents of the editing to the communication terminal 2 and the display terminal 10. A person who wants to correct the voice recognition result (hereinafter referred to as the editor, who may be one of the participants of the event) launches a browser application or a Web browser on the PC 5 to connect the PC 5 to the sharing support server 6. Herein, the editor has signed in to the sharing support server 6, and the sharing support server 6 has identified the editor ID of the editor, for example.

At steps S101 and S102, the editor acquires the URL of the storage location of the text data (see the “CONTENT” field in FIG. 7) from the sharing support server 6 by specifying the executed event ID, for example. The executed event ID may be given to the editor verbally or by email from a user who knows the executed event ID. Alternatively, the editor may voluntarily retrieves the executed event ID.

At step S103, the communication unit 51 of the PC 5 connects to the URL of the storage location of the text data. It is assumed in FIG. 26 that the storage location of the text data is in the sharing support server 6. The storage location of the text data, however, may be anywhere on the communication network N, such as in a cloud environment. The communication unit 51 establishes a network session to be constantly connected to the URL of the storage location of the text data. A protocol such as WebSocket or message queueing telemetry transport (MQTT) may be used to establish a session. The established network session enables bidirectional communication, allowing the sharing support server 6 to transmit the text data to the PC 5, the communication terminal 2, and the display terminal 10. When the network session is established, the communication unit 51 acquires all text data generated until the establishment of the network session, and the display control unit 54 causes the display 508 to display the text data.

At steps S104, S105, and S106, the communication unit 21 of the communication terminal 2 transmits the audio data to the audio-to-text conversion server 9. The audio-to-text conversion server 9 then converts the audio data into the text data, as described above with FIG. 24, and returns the converted text data to the sharing support server 6.

At steps S107, S108, and S109, the communication unit 61 of the sharing support server 6 transmits in real time the newly transmitted text data (i.e., the converted text data) to the PC 5, the display terminal 10, and the communication terminal 2, with which the session is established. When the communication unit 51 of the PC 5 receives the text data, the display control unit 54 of the PC 5 causes the display 508 of the PC 5 to display the newly received text data to follow the latest text data being displayed. When the communication unit 11 of the display terminal 10 receives the text data, the display control unit 13 of the display terminal 10 causes the display 508 of the display terminal 10 to display the newly received text data to follow the latest text data being displayed. An operation similar to the above-described operation also takes place in the communication terminal 2. Thereby, the text data displayed on the PC 5 or the display terminal 10 is synchronized in substantially real time with the voice uttered by the user.

At step S110, the editor starts editing the text data of the utterance, and the receiving unit 52 of the PC 5 receives the editing. Herein, to start editing refers to the editor making the cursor movable on the text data to specify the input position. The PC 5 may display an input field for inputting the text data, such as a dialogue box.

At step S111, the communication unit 51 of the PC 5 transmits an editing start notification to the sharing support server 6 by specifying the corresponding text ID.

At steps S112 and S113, the communication unit 61 of the sharing support server 6 receives the editing start notification, and the restriction unit 66 of the sharing support server 6 transmits, via the communication unit 61, an editing prohibition notification to the communication terminal 2 and the display terminal 10, with which the session is established, by specifying the text ID and the editor ID identified based on the sign-in process. Herein, the editor ID is transmitted to the communication terminal 2 and the display terminal 10 to allow the users thereof to recognize who is editing the text data. Alternatively, the editor name may be transmitted to the communication terminal 2 and the display terminal 10 in place of the editor ID.

At steps S114 and S115, the communication unit 21 of the communication terminal 2 and the communication unit 11 of the display terminal 10 receive the editing prohibition notification. Then, the receiving unit 22 of the communication terminal 2 and the receiving unit 12 of the display terminal 10 restrict the editing of the text data identified by the text ID. Preferably, the display control unit 24 of the communication terminal 2 and the display control unit 13 of the display terminal 10 highlight the entirety of the edited text data or an edited character of the edited text data. With the editing restricted, even if one of the users attempts to edit the text data, the cursor is not displayed, for example. Further, the display control units 24 and 13 display, as well as the currently edited text data, the editor ID (or the editor name associated with the editor ID) in the form of text or icon.

At step S116, when the editor edits the text data (e.g., changes a given character to another character or adds or deletes a character), the receiving unit 52 of the PC 5 receives the editing.

At step S117, the communication unit 51 of the PC 5 transmits the edited text data to the sharing support server 6 by specifying the corresponding text ID. This transmission takes place in real time. Herein, “in real time” indicates that each time at least one character is deleted or added, the contents of the editing is transmitted. The communication unit 51 may transmit the entirety of the text data, or may transmit an edited character of the text data. If the communication unit 51 transmits the edited character of the text data, the communication unit 51 transmits the number of the edited character in the currently edited text data (i.e., the number of the edited character counted from the first character of the text data) and the post-editing state based on the change, addition, or deletion. If the editing is the change of a character, the communication unit 51 transmits a notification of change and the changed character. If the editing is the addition of a character, the communication unit 51 transmits the position of addition and the added character. If the editing is the deletion of a character, the communication unit 51 transmits a notification of deletion.

At steps S118 and S119, in response to receipt of the edited text data, the communication unit 61 of the sharing support server 6 reflects the editing in the text data, and transmits in real time the contents of the editing to the communication terminal 2 and the display terminal 10 (and another PC 5 for editing, if any), with which the session is established. The text data may be being displayed on the communication terminal 2 and the display terminal 10, for example. When the content of the utterance is corrected on the PC 5, therefore, the text data displayed on the display terminal 10 is synchronized in substantially real time with the corrected content.

The communication unit 61 of the sharing support server 6 may transmit, as well as the edited text data, the user identification information of the user (i.e., the editor) currently editing the text data to the communication terminal 2 and the display terminal 10. Then, if the user identification information of the editor who has started the editing (i.e., the user identification information acquired at steps S112 and S113) matches the user identification information transmitted from the sharing support server 6, the communication terminal 2 and the display terminal 10 may reflect the editing in the text data identified by the text ID. Alternatively, when the received text data does not match the original text data, the communication terminal 2 and the display terminal 10 may reflect the editing in the text data. That is, the communication unit 61 does not necessarily transmit an instruction to reflect the editing in the text data.

At steps S120 and S121, the communication unit 21 of the communication terminal 2 and the communication unit 11 of the display terminal 10 receive the edited text data, and the editing is reflected in the text data identified by the text ID. That is, the display control unit 24 of the communication terminal 2 and the display control unit 13 of the display terminal 10 replace the entirety of the currently displayed text data with the received text data, or replace the corresponding character of the currently displayed text data with the edited character of the received text data. Preferably, the display control units 24 and 13 cause the display 508 to display in highlight the entirety of the edited text data or the edited character of the edited text data. The display in highlight will be described later.

If the editor confirms the editing by pressing the return key, completes the editing by pressing the escape key, or releases the selection of the currently edited text data by selecting another text data, the cursor key disappears. In response to receipt of a release notification, the restriction unit 66 of the sharing support server 6 lifts the restriction on the display terminal 10 and the communication terminal 2.

A display example of the text data will be described.

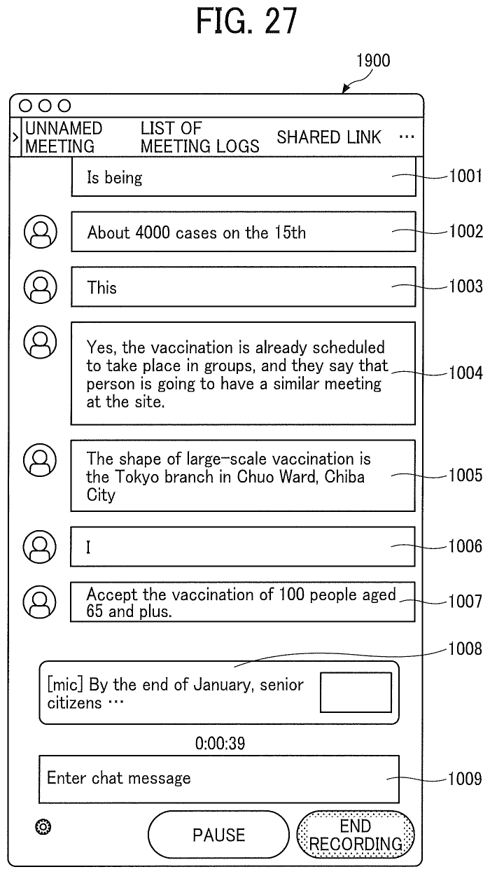

FIG. 27 illustrates an exemplary text display screen 1900 displayed by the display terminal 10. The text display screen 1900 includes text data items 1001, 1002, 1003, 1004, 1005, 1006, and 1007 divided into blocks in accordance with uttered sentences in utterances, currently recognized text 1008, and a chat input field 1009. When new text data is added, the text data items 1001 to 1007 in FIG. 27 are scrolled down to display the latest text data converted from the audio data. As illustrated in the content management table in FIG. 7, the start time and the end time of the utterance are recorded for each text data.

The currently recognized text 1008 displays part of the text data of an utterance of a user currently in voice recognition. The currently recognized text 1008 is a character string yet to be confirmed as an uttered sentence.

A text data editing screen displayed by the PC 5 will be described.

As a supplementary explanation of the editor, the editor is a person who corrects the text data for those who want to view in real time the text data corresponding to the audio data of the utterances made in the meeting or a person who wants to correct the text data to be used as the minutes of the meeting. Herein, those who want to view in real time the text data include a person with hearing loss or difficulty. The present embodiment, however, is also useful to other people.

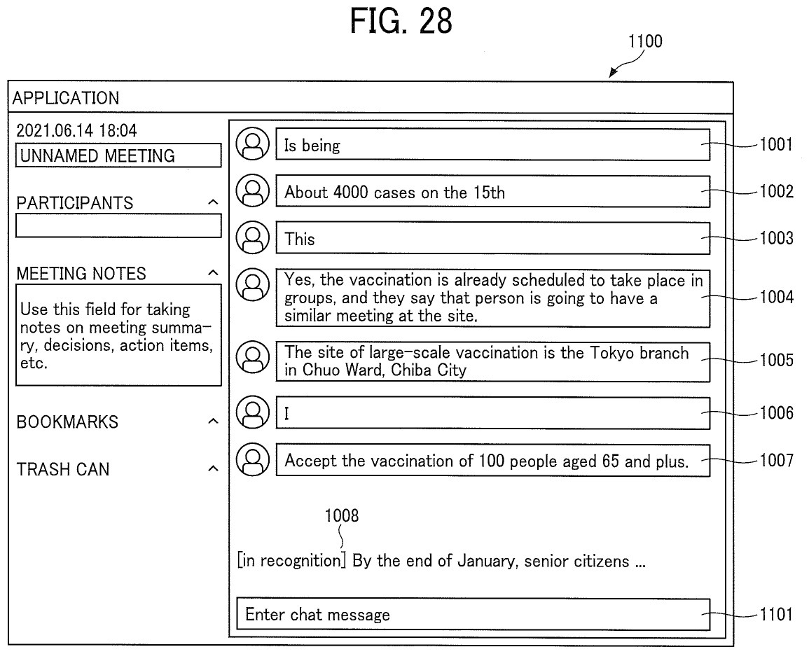

FIG. 28 illustrates an exemplary text data editing screen 1100 displayed by the PC 5. It is assumed here that the text data editing screen 1100 in FIG. 28 is displayed by a dedicated application running on the PC 5. The editing may also be performed on the display terminal 10. As illustrated in FIG. 28, the text data is displayed in substantially real time on the PC 5 similarly as on the display terminal 10. The editor is able to correct incorrect part of the text data by comparing the remembered content of utterance with the text data.

For example, in the present example, the editor has corrected the text data item 1005 from “The shape of large-scale vaccination is the Tokyo branch in Chuo Ward, Chiba City” to “The site of large-scale vaccination is the Tokyo branch in Chuo Ward, Chiba City.”

The corrected text data item 1005 reading “The site of large-scale vaccination is the Tokyo branch in Chuo Ward, Chiba City” or the changed word “site” made of four characters is transmitted to the display terminal 10 via the sharing support server 6. Therefore, the text data being displayed by the display terminal 10 is changed in real time.

The currently recognized text 1008 and a chat input field 1101 in FIG. 28 displayed by the PC 5 may be similar to the currently recognized text 1008 and the chat input field 1009 in FIG. 27, respectively, which are displayed by the display terminal 10.

A detailed display example of the text data editing screen will be described.

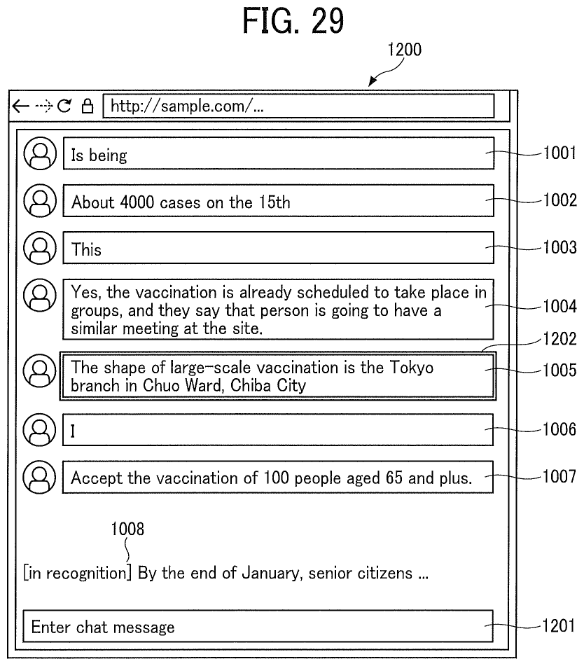

FIG. 29 is a detailed diagram illustrating a text data editing screen 1200. FIG. 29 illustrates an example in which the text data editing screen 1200 is displayed by a Web browser. The configuration of the text data editing screen 1200 may be similar to that of the screen displayed by an application. To edit the text data, the editor presses (e.g., clicks) particular one of the displayed text data items 1001 to 1007. The pressing corresponds to starting the editing. Thereby, a frame 1202 and a cursor are displayed on the text data editing screen 1200, allowing the editor to edit the text data item in the frame 1202.

It is assumed here that the text data item 1005 has been selected. During the editing, the text data item 1005 is displayed in highlight with the frame 1202 in a color such as yellow, for example. The display terminal 10 and the communication terminal 2 are also notified of the text data item 1005 being edited. On the display terminal 10 and the communication terminal 2, therefore, the text data item 1005 is displayed in highlight similarly as on the PC 5. Further, the editing of the text data item 1005 is restricted on the display terminal 10 and the communication terminal 2; the users of the display terminal 10 and the communication terminal 2 are prevented from placing the cursor over the text data item 1005.

The frame 1202 is displayed in any color with a highlighting effect (e.g., red or orange), and may be flashed by the display control unit 54. The display control unit 54 may change the color of the area of the text data item 1005, change the color of the text data item 1005, or increase the font size or line width of the text data item 1005.

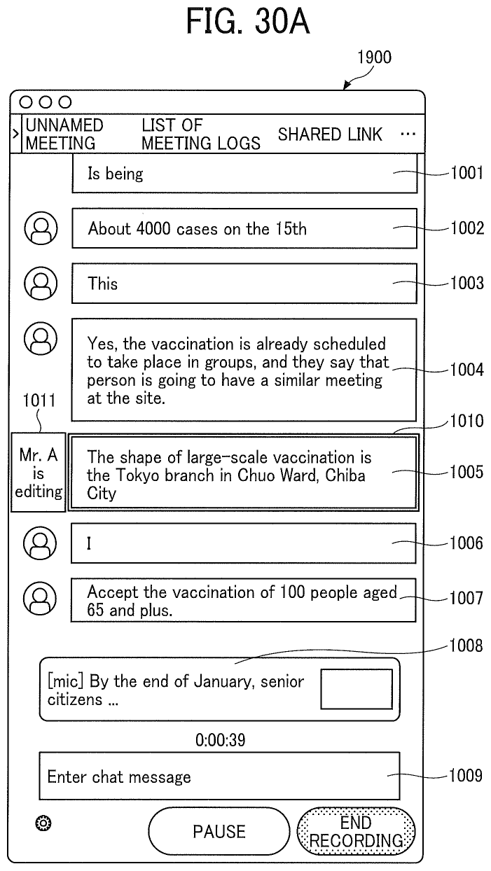

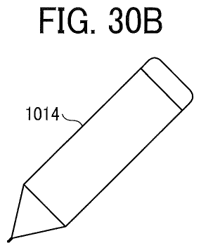

FIG. 30A illustrates a currently edited text display screen 1900 displayed by the display terminal 10. A message 1011 reading “Mr. A is editing” is displayed in association with the text data item 1005, which is being edited by the editor. This display example is illustrative. Therefore, the display terminal 10 may display the editor name and an icon indicating that the editing is in progress (e.g., a pencil icon), or may not display the editor name.

FIG. 30B illustrates an exemplary icon 1014 displayed in place of the message 1011. With the icon 1014, the users recognize that the text data item 1005 is being edited. The icon 1014 may be displayed together with the message 1011.

The text data item 1005 is also displayed with a frame 1010 on the text display screen 1900 displayed by the display terminal 10, indicating that the text data item 1005 is being edited. That is, the text data item 1005 is displayed as enclosed in a frame. The frame 1010 may be displayed in a color with a highlighting effect (e.g., red or orange), and may be flashed by the display control unit 13. The display control unit 13 may change the color of the area of the text data item 1005, change the color of the text data item 1005, or increase the font size or line width of the text data item 1005.

The screen displayed by the PC 5 and the screen displayed by the display terminal 10 are not necessarily synchronized with each other (the PC 5 and the display terminal 10 are different in screen size, for example). Therefore, not all text data displayed by the PC 5 may be displayed by the display terminal 10. If the editor edits the text data displayed by the PC 5 but not by the display terminal 10, the display terminal 10 may temporarily hold the edited text data and then display the edited text data, as illustrated in FIG. 30A, when the user causes the display terminal 10 to display the text data.

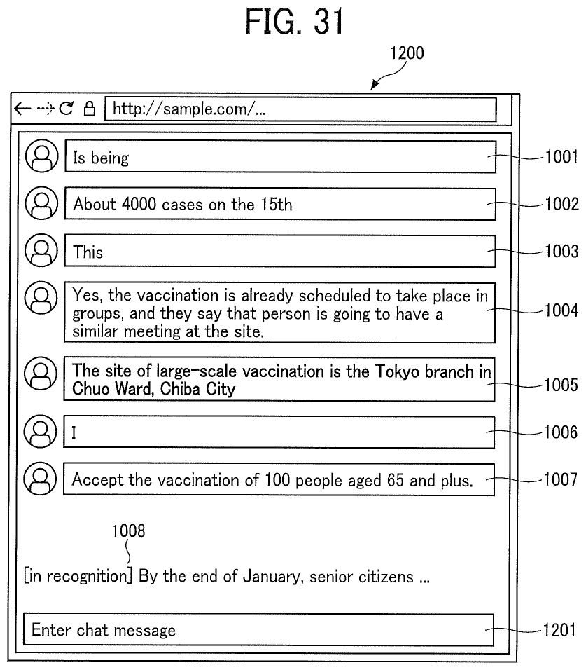

FIG. 31 illustrates an exemplary text data editing screen 1200 displayed after the editing of the text data item 1005. When the editor completes the editing (e.g., presses the return key to hide the cursor), the entirety of the edited text data item 1005 or the edited character of the edited text data item 1005 is displayed in red, for example. The color of the edited text data or character is not limited to red, and may be any color visually noticeably indicating that the text data or character has been edited. In FIG. 31, the entirety of the text data item 1005 is displayed in bold. The edited text data or character may be displayed in a color other than red. Further, the edited text data item 1005 may be enclosed in a frame, or the area of the edited text data item 1005 may be colored. Further, the edited text data item 1005 may be displayed with text decoration (e.g., italic or bold).

The edited text data item 1005 is registered in the text information management table in FIG. 12 together with the editor ID. This process also takes place during the editing (i.e., in a state in which the frame 1202 in FIG. 29 is displayed), allowing the display terminal 10 to share in real time the information about the editor during the editing. The other users are therefore able to recognize at a glance who is editing the text data. Further, the sharing support server 6 is capable of restricting the editing by the other users.

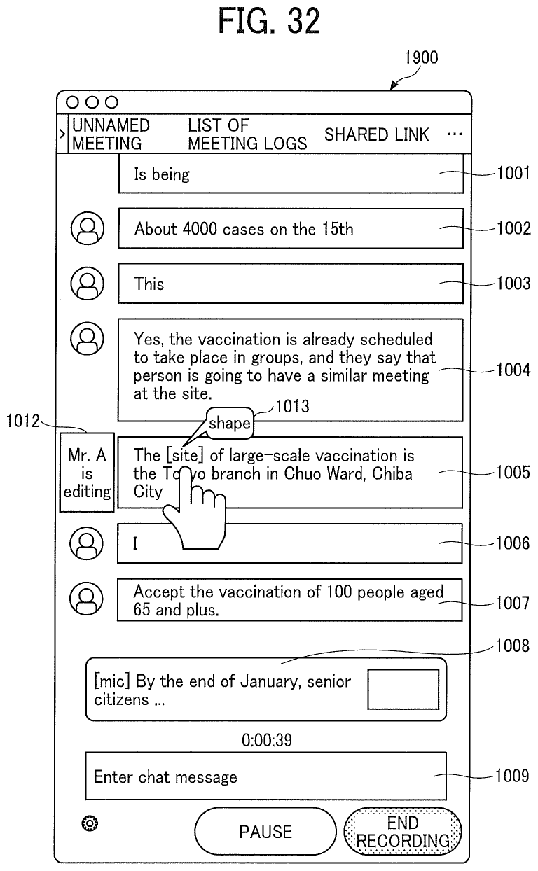

Each time the text data is edited by the editor, the contents of the editing are transmitted to the sharing support server 6, and the text information management table is updated. The updated text data is transmitted to the display terminal 10. Thereby, the text data displayed by the display terminal 10 is also updated in real time. If the editor edits the text “shape” into “site,” the change from “shape” to “site” also occurs in substantially real time in the text data displayed by the display terminal 10, as illustrated in FIG. 32.

FIG. 32 illustrates the edited text data item 1005 displayed by the display terminal 10. In FIG. 32, a message 1012 reading “Mr. A is editing” is displayed in association with the text data item 1005 edited by the editor. This display example is illustrative. The display terminal 10 may therefore display the editor name and an icon indicating that the text data item 1005 has been edited, or may not display the editor name. Further, the edited text data item 1005 may be displayed in a color other than red, or may be enclosed in a frame. Further, the area of the edited text data item 1005 may be colored, or the edited text data item 1005 may be displayed with text decoration (e.g., italic or bold).

If the user taps the edited text data item 1005, pre-editing characters 1013 (i.e., “shape”) and post-editing characters (i.e., “site”) are displayed at the same time. Thereby, the user is able to check both pre-editing text data and post-editing text data. Alternatively, the display control unit 13 of the display terminal 10 may display, instead of the changed characters, the entirety of the pre-editing text data item 1005 and the entirety of the post-editing text data item 1005.

A description will be given of the display of content after the completion of the meeting.

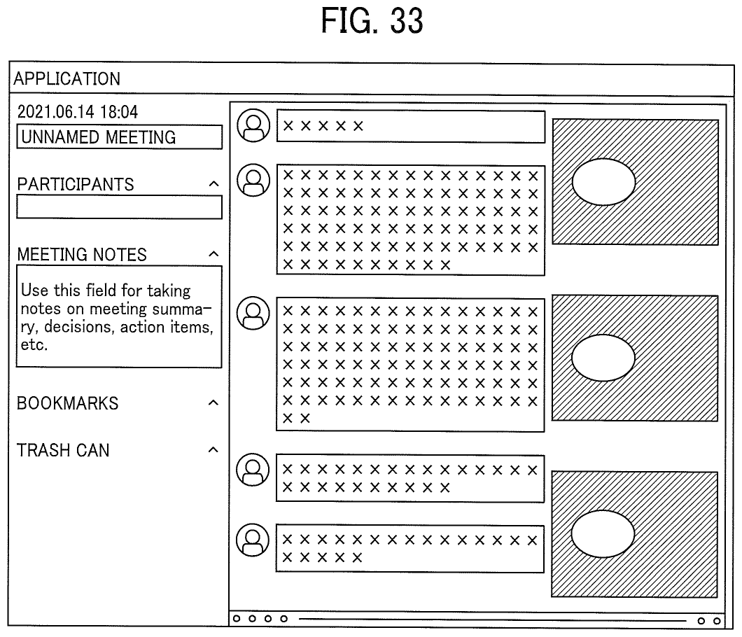

FIG. 33 illustrates an exemplary content display screen displayed after the completion of the meeting. As a display example of content after the completion of the meeting, presentation material used in the meeting corresponding to the text data is displayed. The content may be thus distributed. Alternatively, the presentation material may be distributed with a passcode attached thereto.

As described above, according to the sharing support server 6 of the present embodiment, the text data edited by the editor is displayed in substantially real time on the display terminal 10 of the viewer. For example, in a case in which a person with hearing difficulty relies on the text data generated by the voice recognition to understand the contents of the meeting, the text data is promptly corrected, helping the person to correctly understand the contents of the meeting. Further, in a case in which the editor later corrects the text data, an increase in the volume of text data makes it difficult for the editor to accurately correct the text data due to the limited memory capacity of the human brain. The present embodiment facilitates real-time correction of the text data by the editor, thereby reducing the workload on the editor.

In the above-described configuration examples such as the example in FIGS. 5A and 5B, the processes of the communication terminal 2, the PC 5, the sharing support server 6, the schedule management server 8, the audio-to-text conversion server 9, and the display terminal 10 are divided in accordance with major functions of these terminals and servers to facilitate the understanding of the processes. The disclosure of the present application should not be limited by how the processing units are divided or by the names of the processing units. The processes of the communication terminal 2, the PC 5, the sharing support server 6, the schedule management server 8, the audio-to-text conversion server 9, and the display terminal 10 may be divided into a larger number of processing units in accordance with the processes. Further, the processes may be divided such that one of the processing units includes a plurality of processes.

The apparatuses described in the exemplary embodiment form one of a plurality of computing environments for implementing the embodiment disclosed in the present specification. In an embodiment of the present invention, the sharing support server 6 is a server cluster including a plurality of computing devices configured to communicate with each other via a desired type of communication link such as a network or a shared memory, for example, to execute the processes disclosed in the present specification.

Further, the sharing support server 6 may be configured to share the process steps disclosed in the embodiment, such as those illustrated in FIG. 26, for example, in various combinations. For example, a process executed by a particular unit may be executed by a plurality of information processing devices included in the sharing support server 6. Further, the components of the sharing support server 6 may be integrated in a single server, or may be distributed to a plurality of apparatuses.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor programmed to perform the recited functions with software, such as a processor implemented by an electronic circuit, as a processor includes circuitry. A processing circuit also includes devices such as an application specific integrated circuit (ASIC), digital signal processor (DSP), field programmable gate array (FPGA), and conventional circuit modules arranged to perform the recited functions. Further, the above-described steps are not limited to the order disclosed herein.

1. An information processing apparatus to communicate with a plurality of terminals via a network, the information processing apparatus comprising circuitry configured to
transmit text data to a first terminal and a second terminal of the plurality of terminals, the text data being converted from audio data transmitted from a particular terminal of the plurality of terminals,
in response to receipt of a notification of start of editing the text data from the first terminal, restrict editing of the text data by the second terminal, and
in response to receipt of the edited text data from the first terminal, transmit at least an edited character of the edited text data to the second terminal.

2. The information processing apparatus of claim 1, wherein the circuitry transmits in real time the text data to the first terminal and the second terminal, and
wherein the at least edited character of the edited text data transmitted to the second terminal is being displayed by the second terminal.

3. The information processing apparatus of claim 1, wherein the circuitry requests the second terminal to display the text data, the editing of which by the second terminal is restricted, in a frame, in a colored area, or with text decoration.

4. The information processing apparatus of claim 1, wherein the circuitry requests the second terminal to display the at least edited character of the edited text data in a frame, in a colored area, or with text decoration.

5. The information processing apparatus of claim 3, wherein the circuitry
receives information of an editor of the text data from the first terminal, and
requests the second terminal to display the information of the editor as well as the text data, the editing of which by the second terminal is restricted.

6. The information processing apparatus of claim 4, wherein the circuitry
receives information of an editor of the text data from the first terminal, and
requests the second terminal to display the information of the editor as well as the at least edited character of the edited text data.

7. The information processing apparatus of claim 5, wherein the information of the editor is a user name or an icon representing the editor.

8. The information processing apparatus of claim 1, wherein in response to receipt of a notification of release of the text data, the circuitry lifts the restriction of the editing of the text data by the second terminal.

9. The information processing apparatus of claim 1, wherein the circuitry transmits identification information for reflecting the editing in the text data to the second terminal as well as the at least edited character of the edited text data.

10. A text data editing method performed by an information processing apparatus that communicates with a plurality of terminals via a network, the text data editing method comprising:
transmitting text data to a first terminal and a second terminal of the plurality of terminals, the text data being converted from audio data transmitted from a particular terminal of the plurality of terminals;
in response to receipt of a notification of start of editing the text data from the first terminal, restricting editing of the text data by the second terminal; and
in response to receipt of the edited text data from the first terminal, transmitting at least an edited character of the edited text data to the second terminal.

11. The text data editing method of claim 10, wherein the transmitting the text data includes transmitting in real time the text data to the first terminal and the second terminal, and
wherein the at least edited character of the edited text data transmitted to the second terminal is being displayed by the second terminal.

12. The text data editing method of claim 10, further comprising requesting the second terminal to display the text data, the editing of which by the second terminal is restricted, in a frame, in a colored area, or with text decoration.

13. The text data editing method of claim 10, further comprising requesting the second terminal to display the at least edited character of the edited text data in a frame, in a colored area, or with text decoration.

14. The text data editing method of claim 12, further comprising:
receiving information of an editor of the text data from the first terminal; and
requesting the second terminal to display the information of the editor as well as the text data, the editing of which by the second terminal is restricted.

15. The text data editing method of claim 13, further comprising:
receiving information of an editor of the text data from the first terminal; and
requesting the second terminal to display the information of the editor as well as the at least edited character of the edited text data.

16. The text data editing method of claim 14, wherein the information of the editor is a user name or an icon representing the editor.

17. The text data editing method of claim 10, further comprising:
receiving a notification of release of the text data; and
lifting the restriction of the editing of the text data by the second terminal.

18. A communication system comprising:
a plurality of terminals including a first terminal and a second terminal; and
an information processing apparatus configured to communicate with the plurality of terminals via a network,
the information processing apparatus including apparatus circuitry configured to
transmit text data to the first terminal and the second terminal, the text data being converted from audio data transmitted from a particular terminal of the plurality of terminals,
in response to receipt of a notification of start of editing the text data from the first terminal, restrict editing of the text data by the second terminal, and
in response to receipt of the edited text data from the first terminal, transmit at least an edited character of the edited text data to the second terminal,
the first terminal including first terminal circuitry configured to
display the text data received from the information processing apparatus, and
receive the editing of the text data, and
the second terminal including second terminal circuitry configured to
display the text data received from the information processing apparatus, and
based on the at least edited character of the edited text data received from the information processing apparatus, change the text data being displayed.
